(19) United States
(12) Patent Application Publication
(10) Pub. No.: US 2010/0104904 A1
(43) Pub. Date: Apr. 29, 2010

(54) System For Generating Electrical Energy Comprising An Electrochemical Reformer And A Fuel Cell

(76) Inventors: Vineet Rao, Garching (DE); Siegfried Schreier, Freising (DE)

Correspondence Address: ST. ONGE STEWARD JOHNSTON & REENS, LLC, 986 BEDFORD STREET, STAMFORD, CT, 06905-5619, US

(21) Appl. No.: 12/605,923

(22) Filed: Oct. 26, 2009

Related U.S. Application Data
(63) Continuation of application No. PCT/EP2008/055076, filed on Apr. 25, 2008.

(30) Foreign Application Priority Data
Apr. 26, 2007 (EP) 07008545.1
Oct. 2, 2007 (EP) 07117793.5

(51) Int. Cl. H01M 8/06

(52) U.S. Cl. 429/21

(57) ABSTRACT

A system for generating electrical energy comprises an electrochemical reformer for converting fuel into a fuel gas. The fuel gas is supplied to a separator, which removes fuel components from the gas flow to a generator, which uses the fuel gas for generating electrical energy. Electrical power needed for the operation of the reformer is supplied by the generator. An external electric load can also be supplied with electrical energy.

### CROSS-REFERENCE TO RELATED APPLICATIONS

The present application is a continuation of pending International patent application PCT/EP2008/055076 filed on Apr. 25, 2008, which designates the United States and claims priority of European patent application No. 07 008 545.1 filed on Apr. 26, 2007 and the priority of European patent application No. 07 117 793.5 filed on Oct. 2, 2007. The disclosure of these applications is hereby incorporated by reference in its entirety as part of the present disclosure.

### FIELD OF THE INVENTION

The invention relates to a system for generating electrical energy comprising:

a fuel reservoir for storage of an organic fuel;

an electrochemical reformer provided with electrical current terminals and arranged for converting the fuel from the fuel reservoir into fuel gas provided at a fuel gas outlet of the reformer;

an electrochemical generator having a fuel gas inlet connected to the fuel gas outlet of the reformer comprising electrical current terminals connectable to an external load and arranged for the production of electrical energy using the fuel gas;

an electrical connection between the electrical current generator and the reformer for supplying electrical energy generated by the generator to the electrical current terminals of the reformer.

### BACKGROUND OF THE INVENTION

Such a system is known from US 2004/0137290 A1. The known system comprises an electrochemical reformer and a fuel cell. In the reformer, molecular hydrogen is produced which is fed into the fuel cell for producing electrical energy. Part of the electrical energy produced by the fuel cell is used to power the reformer. During operation, the reformer is pressurized. In a conduit provided for the transport from the reformer to the fuel cell a pressure regulator may be disposed. The known system runs on methanol and allows the construction of a compact, portable power source.

JP 2006 339071 A discloses a similar system comprising an electrochemical reformer running on propanol and producing molecular hydrogen which is fed into a fuel cell connected to the electrochemical reformer via a vapor-liquid separator and a hydrogen separator. The electrical power produced in the in fuel cell is partially used to run the electrochemical reformer. The known system provides a fuel cell system which allows frequent starting and stopping with a short starting time.

Another type of a system is known from U.S. Pat. No. 5,599,638. The known system comprises a fuel tank in which a mixture of methanol and water is stored. The mixture of water and methanol is circulated past an anode of a cell while oxygen or air is circulated past a cathode of the same cell. A solid electrolyte membrane is disposed between the anode and the cathode of the cell. Systems of this type are also called Direct Methanol Fuel Cells (=DMFC)

Fuel cells of this type are systems, which convert chemical energy into electrical energy. The most important part of the DMFC is the Membrane Electrode Assembly (=MEA) which comprises a membrane disposed between two catalytically active electrodes, the anode and the cathode. The anode and cathode materials, which could be platinum-based or other ones, are mostly prepared in nanoparticle powder form. The catalyst can be deposited by different processes on the membrane, such as wet coating, screen-printing, decal method or other methods.

The methanol gets deprotonated at the anode of the MEA and the protons thus produced, diffuse through a proton conducting electrolyte and reach at the cathode, where they react with the oxygen supplied to the cathode. The reduction of the protons by oxygen results in the production of water.

Hydroxyl ion (OH—) conducting polymer electrolyte membranes have also recently been used in fuel cells. But these membranes are still under investigation.

If fuels other than methanol are used, the fuel cells are also called Direct Oxidation Fuel Cells (=DOFC). The direct oxidation fuel cells avoid the use of fuel reformers, but also have some drawbacks. DOFCs with a liquid phase on one side and a gas phase on the other side and the polymer electrolyte membrane as a separator run into serious problems since the membranes are not completely tight to fuel and water. This leads to the following problems, which shall be explained taking a DMFC as an example.

One of these problems is methanol crossover. Methanol crossover not only leads to fuel loss but also to mixed potential effects and thus lowers cell voltage. Additionally methanol on the cathode side undergoes heterogeneous oxidation at Pt sites consuming oxygen and thus reduces the oxygen availability for useful electrochemical reaction. In consequence, higher stoichiometric flows of oxygen are required.

Methanol crossover also contributes to the problem of cathode flooding which creates the mass transport problem in the cathode. Methanol crossover in DMFC system results in up to 40% fuel loss, reducing the volumetric energy density of the system.

Water crossover also creates the flooding of the cathode, which hinders the oxygen access to the catalyst and deteriorates the performance of the cathode.

High catalyst loading is also required due to the bad cathode performance caused by water and methanol crossover. For example typical cathode loading in Proton Exchange Membrane Fuel Cells (=PEMFC) is 0.4 mg/cm², but in DOFC it is around 4-5 mg/cm².

High airflow and stoichiometry on the cathode side is further required to remove the crossed over water, that floods the cathode, and to additionally compensate for the loss of oxygen in parasitic methanol oxidation reactions. The water on the cathode side stems from diffusion processes and electro-osmotic drag and is also produced by electrochemical reactions and parasitic oxidation processes of methanol at the cathode. This makes a DMFC system more complicated and less efficient, as the air blowers and compressors have to be powered by the DMFC itself, which is problematic especially in portable DMFC systems. The power demand of the compressors and blowers in a DMFC system could reach more than 20% of the overall electrical output of the DMFC stack as discussed in DOHLE, H.; SCHMITZ, H.; BEWER, T.; MERGEL, J.; STOLTEN, D.: Journal of Power Sources 106 (2002) 313-322 and DOHLE, H., MERGEL, J., STOLTEN, D., Journal of power sources 111 (2002) 268-282.

Pressurized cathode operation is required for liquid feed DMFCs to operate at higher temperatures. The elevated pressure helps in controlling the heat losses because of water vaporization. High temperature operation is desirable because of better kinetics at higher temperatures but its realization requires high pressure and thus compressors to create and maintain elevated pressures. The compressors add to the parasitic power requirement of the DMFC system.

Poly-Fluoro Sulphonic Acid (=PFSA) based membranes manufactured by DuPont under the name Nafion are the most widely available proton exchange membranes in the market. But these membranes are permeable to organic fuels (methanol, formic acid, ethanol and other fuels) as well as water and thus cannot work as an effective separator between anode and cathode reactants. Different approaches have been proposed to deal with this problem. Many new polymer electrolytes have been researched for their permeability for methanol and water. Fluorinated, partially fluorinated, non-fluorinated (hydrocarbon and polyarylene), composite membranes (insulator nanoporous matrices filled with inorganic acids) has been investigated. But often a more liquid tight membrane has lower proton conductivity.

Another approach is disclosed in U.S. Pat. No. 6,242,122 B1. In this approach liquid crossover is minimized by using a liquid barrier layer made up of Pd, allowing only protons to pass through. The Pd or Pd alloys placed in the middle of the proton exchange membrane (=PEM) can act as a barrier for water as well as methanol. The Pd foil of the thickness (10-50 microns) can then be coated on both sides with proton conducting polymer. This approach, however, results in high costs, since large amounts of Pd are needed, which is a noble metal and thus costly.

Active methanol concentration control also helps in minimizing the methanol crossover. The amount of methanol, which can crossover to the cathode side in a DMFC, depends on the concentration of methanol on the catalyst layer-membrane interface, and that depends on how much methanol is oxidized in the anode catalyst layer. Taking these points into account and knowing typical current densities of the DMFC, an optimum concentration of methanol in water can be worked out. That is typically around 0.5-2 M Methanol. To maintain the concentration around this optimum requires constant monitoring of concentration and requires a methanol concentration sensor. But even this approach does not completely eliminate methanol crossover and water crossover is simply unaffected.

Methanol tolerant oxygen reduction catalyst at the cathode will make sure that the electrochemical reaction (oxygen reduction) is not hindered by the presence of methanol at the cathode side. Methanol will not undergo chemical oxidation at the catalyst sites, if methanol tolerant catalysts are used. Novel catalysts have been proposed by a number of groups. ALONSO-VANTE, N.; CATTARIN, S.; MUSIANI, M.: Journal of Electroanalytical Chemistry 481 (2000) 200-207 and ALONSO-VANTE, N.; BOGDANOFF, P.; TRIBUTSCH, H.: Journal of Catalysis 190 (2000) 240-246 propose RuSe, YANG, H.; ALONSO-VANTE, N.; LEGER, J. M.; LAMY, C.: Journal of Physical Chemistry B 108 (2004) 1938-1947 propose Pt—Cr and YANG, H.; COUTANCEAU, C.; LEGER, J. M.; ALONSO-VANTE, N.; LAMY, C.: Journal of Electroanalytical Chemistry 576 (2005) 305-313 and YANG H.; VOGEL, W.; LAMY, C.; ALONSO-VANTE, N.: Journal of Physical Chemistry B 108 (2004) 11024-11034 consider Pt—Ni. Furthermore, also Fe and Cobalt tetramethoxy-phenyl-porphyrines have also been proposed for this purpose. But these approaches do not solve the problem of cathode flooding with water and methanol, which creates a mass transport barrier for the oxygen reduction reaction, and thus drastically brings down the performance of the cathode. Furthermore these catalysts are comparatively less active than Pt for the O₂ reduction reaction.

U.S. Pat. No. 6,869,716 B2 discloses a DMFC comprising an anode chamber connected to a conduit having an inlet and through which anodic effluent flows are provided. The conduit contains a porous gas separator through which gaseous components of the effluent flow can pass while liquid components are retained.

US 2003/0095872 A1 discloses a DMFC with a pump for pumping methanol into the cell. The pump is driven by carbon dioxide, produced by the electro-chemical reaction at the anode of the fuel cell.

### SUMMARY OF THE INVENTION

Proceeding from this related art, the present invention seeks to provide an improved system for generating electrical energy.

This object is achieved by a system having the features of the independent claim. Advantageous embodiments and refine-ments are specified in claims dependent thereon.

In the system, a separator is disposed between a reformer and a generator for separating liquids from the fuel gas supplied to the generator. Furthermore, a poisoning tolerant catalyst is used for an electrode on the fuel gas side of the generator. By disposing a separator in the conduit between the reformer and the generator the amount of harmful components arriving at the generator can be significantly reduced. Since these components cannot completely be removed from the gas mixture fed to the generator by the separator a poisoning tolerant catalyst has to be used for an electrode on the fuel gas side of the generator in order to suppress the harmful effect of the remaining components on the efficiency of the generator. The effective suppression of the poisoning of the generator results in lower total catalyst loading needed for the whole system.

In one embodiment, the poisoning tolerant catalyst on the electrode on the fuel gas side of the generator is a catalyst, whose performance is better than the performance of Pt in the presence of fuel vapor and to by-products of the fuel gas generation process on the fuel gas side of the generator under the same operational conditions. Since these by-products can also reduce the efficiency of the system, the catalyst is preferably tolerant to fuel vapor and to the by-products of the fuel gas generation process.

The poisoning tolerant catalyst on the electrode on the fuel gas side of the generator can be based on an alloy comprising Pt and at least one component of the group Sn, Ru, W, Mo, Rh and Re. Such alloys are more fuel tolerant as well as more tolerant to by-products generated in the fuel gas generation process than Pt alone.

Preferably, the fuel concentration in the reformer is chosen below a concentration limit, which depends on the operational temperature of the reformer. At higher temperatures the allowable fuel concentration is lower. By keeping the fuel concentration below the concentration limit, the poisoning effect can be reduced further.

Preferably, the voltage of each elementary cell of the generator is periodically pulsed to a voltage less than 0.5 Volt. Thus, the effect of poisoning can be further suppressed.

The poisoning of the generator can also be mitigated if at least one component selected from the group comprising the reformer, the separator, the fuel reservoir and a condenser for the waste gas is pressurized above ambient pressure for reducing the amount of fuel vapor and fuel oxidation by-products arriving at the generator together with fuel gas.

The amount of catalyst can be reduced if the system runs at elevated operational temperatures because of enhanced kinetics at higher temperatures. It has been found that self heating can be achieved if the choice of pressure is governed by a specific relation between the single cell voltage of the reformer, the total operating pressure of the reformer and the combined partial pressure of fuel and water vapors in the reformer, wherein the combined partial pressure is a function of the temperature and the fuel concentration in a fuel diluting fluid. Since the pressure is build up immediately after the start of the system by the waste gas and fuel gas generated in the reformer, the reformer will be self-heated at elevated temperatures.

In one embodiment, the separator is additional supplied with waste gas from the fuel side of the reformer and a condensate is conducted back to the fuel side of the reformer. In this case, the system works with a mixed output of fuel gas and waste gas from the reformer. Such a reformer with a mixed flow output containing for instance waste gas from the fuel side electrode and fuel gas from an electrode on the fuel gas side has the potential for miniaturization since only a single pressure regulator and fuel reservoir is needed for the whole system.

Preferably, the catalyst loading of an electrode on the fuel side of at least one elementary cell of the reformer is higher than the catalyst loading of an electrode on the fuel gas side of the elementary cell of the reformer. Thus, the amount of catalyst can be minimized. In particular the total amount of catalyst used for an electrode on the fuel side of the reformer can be higher than the total amount of catalyst used for an effective cathode comprising the electrode on the fuel gas side of the reformer and the electrodes in the generator.

The operational temperature of the reformer and of the generator can be chosen such that the system power per total catalyst loading exceeds 100 W/g at an actual power density above 100 mW/cm² and at an energy conversion efficiency between 10% and 30% or that the system power per total catalyst loading exceeds 30 W/g at an actual power density above 40 mW/cm² and an energy conversion efficiency above 30%. Thus, the catalyst loading needed for the system can be minimized which will also result in lower costs of production.

A particularly compact design of the system can be achieved if the reformer comprises a porous membrane electrode assembly and porous gas diffusion layers which are permeable for the fuel, the produced waste gas and fuel gas.

### BRIEF DESCRIPTION OF THE DRAWINGS

Further advantages and properties of the present invention are disclosed in the following description, in which exemplary embodiments of the present invention are explained in detail on the basis of the drawings:

FIG. 1 shows a block diagram of a prior art acidic Direct Oxidation Fuel Cell (=DOFC);

FIG. 2 is a diagram with the anode and cathode over-potentials and the voltage-current-characteristic of a fuel cell according to FIG. 1;

FIG. 3 shows a cross section of a prior art alkaline Direct Oxidation Fuel Cell (=DOFC);

FIG. 4 shows a block diagram of a system for generating electrical energy with an electrolyzer and a separate fuel cell;

FIG. 5 is a diagram showing the current densities measured on different electrolyzers of a system according to FIG. 4;

FIG. 6 is a diagram showing the voltage-current-characteristics of various components of systems according to FIG. 4 with different catalyst loadings;

FIG. 7 is a diagram illustrating the dependency of the power density on the current of the system according to FIG. 4;

FIG. 8 is a diagram, which contains voltage-current-characteristics of electrolyzers with different cathode catalyst loadings;

FIG. 9 is a block diagram illustrating the effective catalyst loading;

FIG. 10 depicts the structure of a porous membrane-electrode-assembly;

FIG. 11 shows an embodiment of a system with a separate flow of hydrogen and carbon dioxide;

FIG. 12 shows an embodiment of a system with a mixed flow of hydrogen and carbon dioxide;

FIG. 13 depicts a block diagram of a system in which the electrolyzer is placed in a fuel reservoir;

FIG. 14 shows a basic electric circuit diagram of a system with the fuel cell and electrolyzer delivering electrical power to an external load;

FIG. 15 is another circuit diagram of a system comprising a fuel cell and an electrolyzer, in which the fuel cell and the electrolyzer are connected in parallel;

FIG. 16 is a block diagram of an embodiment, in which a subunit of the generator is producing the power needed for the reformer whereas another subunit is generating the electrical power for an external load;

FIG. 17 is a block diagram of a modified embodiment of the system according to FIG. 16;

FIG. 18 is another modified embodiment of the system according to FIG. 16;

FIG. 19 is a system according to FIG. 16 with an additional electronic control unit;

FIG. 20 is a block diagram illustrating the flow of energy within a system for generating power having an electrolyzer and a separate fuel cell;

FIG. 21 is a block diagram showing more details of a design of system for generating energy;

FIG. 22 is a diagram showing the dependency of the current-voltage-characteristics of an electrolyzer on temperature;

FIG. 23 is a diagram depicting the voltage-current-characteristic and the dependency of the power output on the current density of a fuel cell;

FIG. 24 is a diagram demonstrating the poisoning effect for a system with a separated flow arrangement;

FIG. 25 is a diagram demonstrating that the influence of the poisoning effect can be kept small by choosing appropriate parameters;

FIG. 26 is a diagram demonstrating the poisoning effect for a system with a mixed flow arrangement; and

FIG. 27 is a diagram demonstrating the performance of the system according to FIG. 11 under different operational conditions.

### DETAILED DESCRIPTION OF THE INVENTION

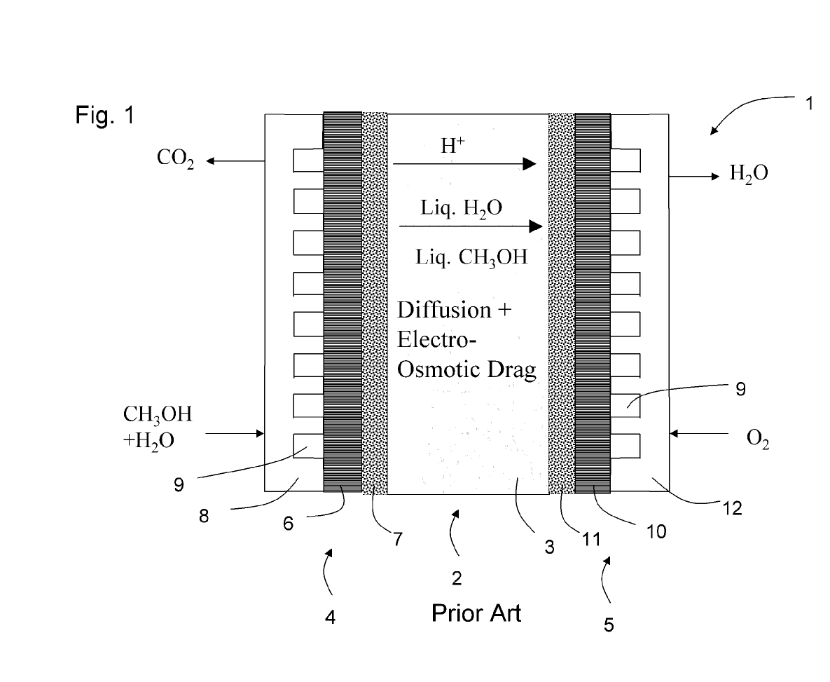

FIG. 1 depicts the working principle of a Direct Oxidation Fuel Cell (=DOFC) 1 which uses methanol. Such a system is also called Direct Methanol Fuel Cell (=DMFC). The most important component of the DOFC 1 is the Membrane Electrode Assembly (=MEA)₂, which consists of a polymer electrolyte membrane 3 also called Proton Exchange Membrane (=PEM), which is capable of conducting protons and has two electrodes on each side, in particular anode 4 and cathode 5.

The anode 4 comprises a diffusion layer 6 and a catalyst layer 7. The catalyst layer 7 is made up of a catalyst which is capable of oxidizing a fuel, for instance methanol, which is transported to the diffusion layer 6 by means of a plate 8 having flow channels 9. Each organic fuel can have its own optimized catalyst. For example, for methanol oxidation in acidic electrolyte, PtRu (1:1) is known to be the best catalyst. Similarly for ethanol oxidation the optimized catalyst known up to now is PtSn and a Pd based catalyst is reported to be the most efficient catalyst for formic acid oxidation.

The cathode 5 comprises also a diffusion layer 10 and a catalyst layer 11. The catalyst layer 11 is made up of a catalyst, which is capable of reducing O₂ to H₂O by taking protons coming from the anode 4 and O₂, which is feeded to the diffusion layer 10 via a plate 12. Generally Pt based catalyst show good activity for O₂ reduction process. But other catalysts like RuSe, Pt—Cr and Pt—Ni have also been proposed for the same purpose. In particular RuSe is methanol tolerant but also has a lower activity than Pt.

If the DOFC 1 is placed in a stack the plates 8 and 9 may be replaced by bipolar plates.

In the DOFC 1 the organic fuel is oxidized at the anode 4 to protons and CO₂. The protons flow through the electrolyte membrane 3 to the cathode 5, where they are used in the cathodic O₂ reduction process producing water.

CH₃OH+H₂O->6H⁺+CO₂+6e⁻at Anode (1)

3/2O₂+6H⁺+6e⁻->3H₂O at Cathode (2)

In the DOFC 1 the feed of the anode 4 is generally a fuel water mixture, as water is needed in the oxidation reaction. The Cathode 5 is fed with air. But the proton-exchange membrane 3, which conducts protons, is not completely tight for liquids. The water and methanol molecules permeate to the side of the cathode 5 by two mechanisms namely diffusion and electro osmotic drag. Diffusion is driven by the concentration gradient, as we have almost unity concentration on the anode side and zero concentration on cathode side due to air on the cathode side of the MEA. Electro osmosis is the process in which the protons drag the water molecules which are part of their solvation shell from the anode 4 to the cathode 5. Both these mechanisms transport water and fuel to the cathode side, which leads to methanol crossover and cathode flooding. Methanol crossover or fuel crossover from the anode to the cathode side affects the functioning of the cathode 5 in a way that leads to mixed potential effects because of the mixing of reactants.

The crossed-over fuel also undergoes chemical heterogeneous oxidation on active catalyst (Pt) sites consuming oxygen and thus producing heat and CO₂ and water. This parasitic parallel non-electrochemical reaction not only leads to fuel loss but also hinders the O₂ supply for the useful electrochemical O₂ reduction reaction. Thus it causes mass-transport overpotential losses on the cathode side.

Cathode flooding is the phenomena caused by the liquid water, which comes to the cathode side by diffusion or electro-osmotic drag from the aqueous phase anode side, and also caused by the water produced in the parasitic oxidation of crossed-over methanol at the cathode side of the DOFC 1. This liquid water can create a water film barrier in the diffusion layer 10 and the catalyst layer 11. This liquid water film hinders the O₂ diffusion to the catalyst layer 11 and thus gives rise to the mass-transport overpotential losses on the cathode 5. Using an appropriate hydrophobic material in the catalyst layer 11 and diffusion layer 10 can solve the problem of cathode flooding to some extent as it is solved in fuel cell, which produces electrical power from H₂ and O₂. This type of fuel cell is also referred to as proton exchange membrane fuel cell (=PEMFC). In comparison to the cathode flooding in PEMFCs, cathode flooding in the DOFC 1 is caused by the presence of aqueous anode 4 which leads to much higher water and fuel crossover rates. It should be noted, that all organic fuels permeate through the PEM to different extent.

In the DOFC 1 there is excess liquid water at the cathode 5. Air flow at the cathode 5 leads to water vaporization. With higher operating temperatures more and more water is vaporized leading to heat losses. The electrical efficiency of the DOFC 1 is generally low. About 20 to 30% of the available energy is converted into electrical energy. The rest is converted into heat energy. The crossed-over fuel is also a source of heat as it is completely oxidized at the cathode side. But still with increasing temperature and air flow rates the heat lost because of water vaporization at the cathode side becomes greater than the heat produced. One way to avoid the heat loss from the cathode side is to operate the cathode side at elevated pressures. The elevated pressures reduce the water vaporization and thus reduce the heat loss. But the elevated pressures at the cathode side require compressors and blowers, which consume a significant part (15-20%) of the electrical power output of the DOFC 1, and also increase the volume and the complexity of the system.

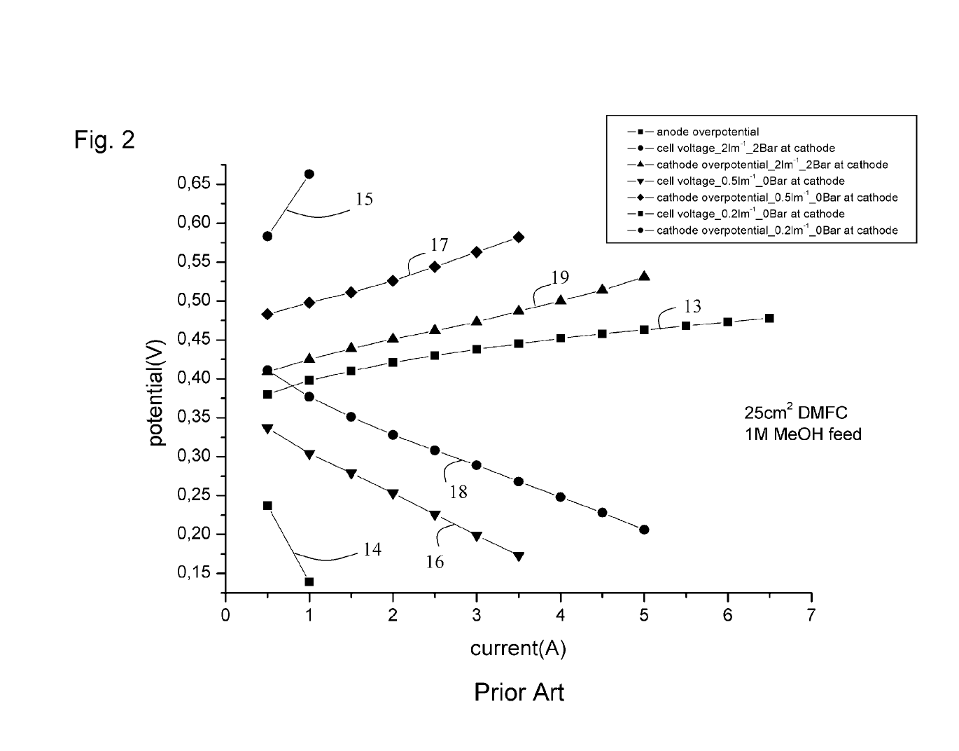

FIG. 2 shows the performance of the DOFC 1 as a function of cathode operating conditions, in particular air flow rate and pressure. The anode overpotential as a function of current is also shown. Since the cathode conditions do not affect the anode 4, the cathode overpotential as a function of current can be deduced if the cell U-I characteristics and the anode half-cell characteristic, and the cell resistance is known. The cathode overpotential are shown in FIG. 2 for different cathode operating conditions. Curve 13 depicts the anode overpotential of the DOFC 1, in which the membrane electrode assembly 2 is 25 m² large and in which fuel with 1 M methanol is fed to the anode side of the DOFC 1. Furthermore, the cell voltage 14 and a cathode overpotential 15 illustrate the behavior of the DOFC 1 at the flow rate of 0.2 l per minute and a pressure of 0 bar at the cathode 5. Furthermore, the voltage 16 and the corresponding cathode overpotential 17 illustrate the behavior of the DOFC 1 at a flow rate of 0.5 l per minute and a pressure of 0 bar at the cathode 5. The cell voltage 18 and a corresponding cathode overpotential 19 finally show the behavior of the fuel cell at a flow rate of 2 l per minute and a pressure of 2 bar at the cathode.

As the air flow rate is reduced, the cathode over potentials rises strongly, even though the flow stoichiometry is always above 10. These experiments show the impact of cathode flooding because of water and methanol crossover. The actual values of the cathode overpotentials will depend on the cathode catalyst loading, properties of the membrane 3, methanol feed concentration on the anode side, air flow stoichiometry, pressure of air and type of flow field on the cathode side.

Since the kinetics of fuel cell processes is better in alkaline medium, solid alkaline anion exchange membranes, which have OH— as the mobile anion may help in improving fuel cells.

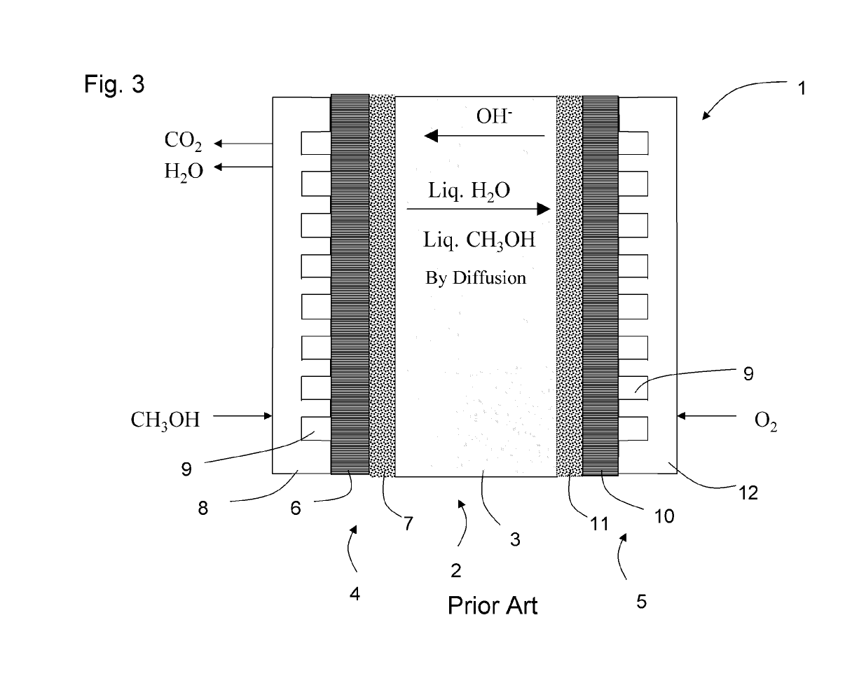

FIG. 3 shows a modified embodiment of the DOFC 1 in which the membrane 3 is a solid Alkaline Anion Exchange Membrane (=AAEM). In case the AAEM is used, some of the processes are reversed. Now water is produced at the anode 4 rather than cathode 5. But still there will be fuel and water diffusion from the liquid phase anode 4 to gas phase cathode 5 simply because of concentration gradient through the AAEM.

### 1. Functional Principle

The solution for these problems is based on separating anode and cathode processes in the DOFC 1. Splitting the anode and cathode processes makes it possible that cathodic processes (O₂ reduction) can take place in gas phase where it is most efficient, without much liquid interference, and anode processes (organic fuel oxidation, for example methanol oxidation) can take place in a liquid phase.

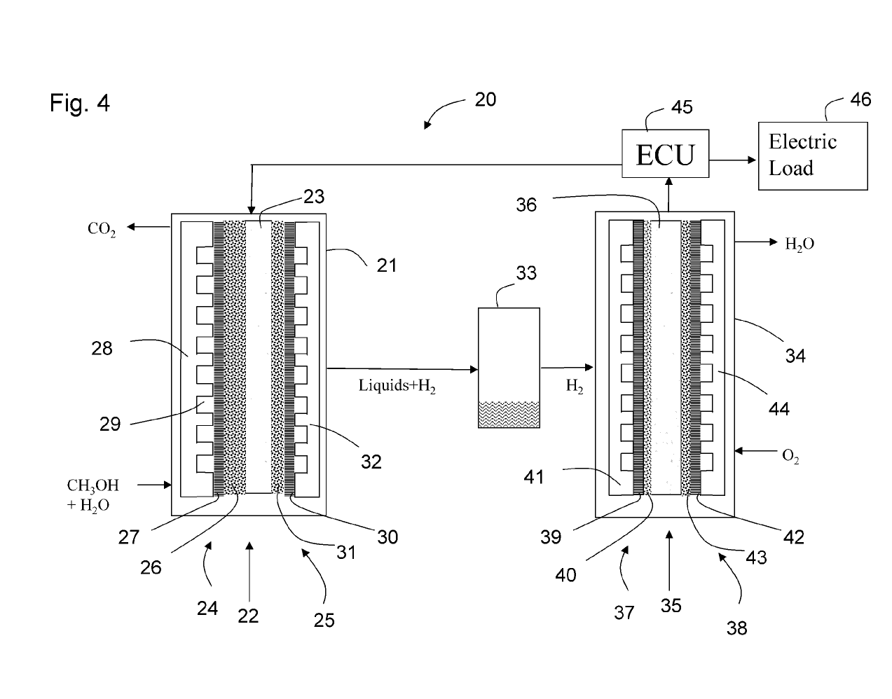

One possible way to achieve this is shown in FIG. 4, which depicts an Electrolyzer Based Direct Methanol Fuel Cell (=EDMFC) 20. The organic fuel methanol is oxidized to H₂ and CO₂ in an electrolyzer 21. The electrolyzer 21 comprises an membrane electrode assembly 22 having a membrane 23 with an anode 24 and a cathode 25 on both sides. The anode 24 comprises a diffusion layer 26 and a catalyst layer 27. On the anode 24 a plate 28 containing flow channels 29 is disposed. The cathode 25 comprises also a diffusion layer 30 and a catalyst layer 31 on which a plate 32 is disposed. The H₂ is produced at the cathode 25 of the electrolyzer 21. Thereafter the H₂ is separated from the crossed over water and methanol by a gas liquid separator 33, which might be a condenser.

In a simplified embodiment, the EDMFC 20 can also be designed without separator 33. In such an embodiment the electrolyzer 21 and a subsequent fuel cell 34 are, for instance, directly connected with a pipe.

The outgoing stream of the separator 33 contains H₂. It can also contain small amounts of the methanol and water vapors, some CO₂ and other products of methanol oxidation reactions, which diffused from the anode 24 to the cathode 25. The stream of hydrogen is then fed to the fuel cell 34, where it can be readily consumed for electrical power generation. The fuel cell 34 works like a conventional PEMFC, using hydrogen and air. The fuel cell 34 further comprises a membrane electrode assembly 35 with a membrane 36, an anode 37 and a cathode 38. The anode 37 comprises a diffusion layer 39 and a catalyst layer 40 on which a plate 41 is disposed. Similarly, the cathode 38 is composed of a diffusion layer 42, a catalyst layer 43 and a plate 44.

The power distribution can be managed by an Electronic Control Unit (=ECU) 45, which can simultaneously feed an electric load 46 and the electrolyzer 21 and all other ancillary units like pumps, blowers, sensors, valves and other devices. An appropriate fraction of the power output of the fuel cell 34 is supplied to the electrolyzer 21. The remaining power is available for the external electric load 46.

The power management in the EDMFC 20 can also be realized without ECU 45. For example, the electrical working points of the electrical components of the system can be matched in an appropriate way. A simplified power balance is discussed in section 4.1. The EDMFC 20 also works if the electrolyzer 21 provides a mixed gas output of H₂ and CO₂. Electrolyzers with mixed gas output could contribute towards miniaturization of the EDMFC system. The anode, cathode and overall reactions of the electrolyzer 21 and the fuel cell 18 are listed in equations 3-8.

Reactions within Electrolyzer 21:

Anode: CH₃OH+H₂O->6H⁺+CO₂+6e⁻ (3)

Cathode: 6H⁺+6e⁻->3H₂ (4)

Overall reaction: CH₃OH+H₂O->CO₂+3H₂ (5)

Reactions within Fuel Cell 34:

Anode: 2H₂->2H⁺+2e⁻ (6)

Cathode: 2H⁺+1/2O₂+2e⁻->H₂O (7)

Overall reaction: H₂+1/2O₂->H₂O (8)

In an experiment for demonstrating the working principle of the EDMFC 20, hydrogen was produced by the oxidation of methanol in a stack consisting of two electrolyzer 21 connected in series. The current through the electrolyzers 21 was controlled by a control unit keeping the voltages on the electrolyzers 21 at a constant value. The hydrogen produced by both electrolyzers 21 was conducted through a condenser. In the condenser the water and the methanol were condensed so that only hydrogen was supplied to the fuel cell.

The electrodes of the electrolyzers 21 and of the fuel cell 34 were provided with a simple meander shaped flow field. The catalyst loading of the anode 37 of the fuel cell 34 was 0.45 mg/cm² Pt—Ru and the catalyst loading of the cathode was 0.4 mg/cm² Pt. The membrane of the electrolyzer 21 was made from Nafion 112 and the anodes 24 were provided with an unsupported catalyst loading of 3.9 mg/cm² Pt—Ru whereas the cathodes 25 comprised a catalyst loading of 0.5 mg/cm² Pt using carbon supported catalyst 40% Pt/C.

The electrolyzers 21 were operated at 90° C. whereas the fuel cell 34 had an operational temperature of 70° C. The condenser worked at room temperature. The A ratio of air was 2.5 and the λ ratio of hydrogen was adjusted slightly above stochiometry corresponding to a current of 0.5 to 1.5 A. The effective area of the membrane in the electrolyzer was two times 25 cm² resulting in a total area of 50 cm². The effective area of the fuel cell amounts to 25 cm² resulting in a total area of 75 cm². The pressure on the cathode side of the electrolyzers 21 was kept at an absolute pressure of 2 bar.

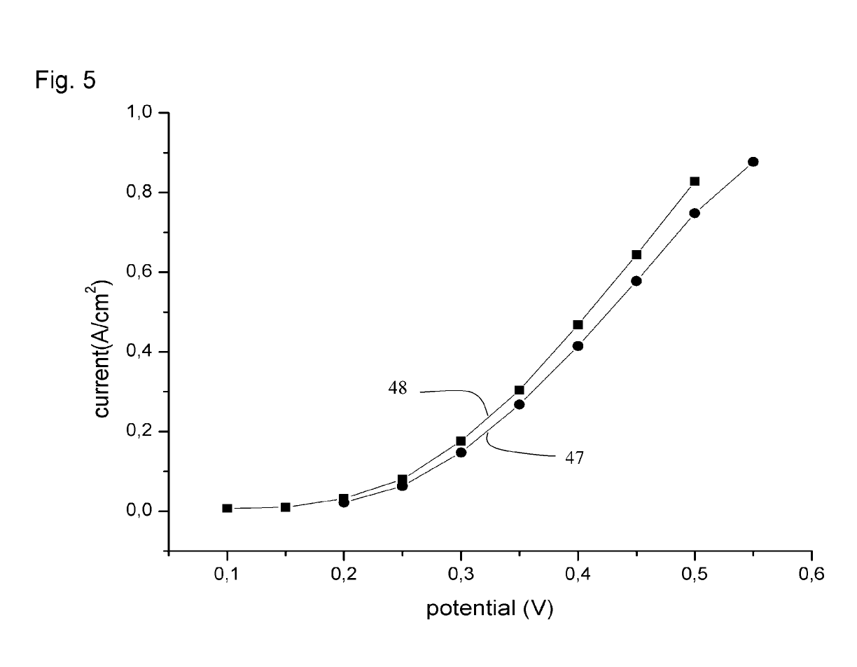

FIG. 5 shows a voltage-current density-characteristic 47 and a voltage-current density-characteristic 48 of both electrolyzers 21.

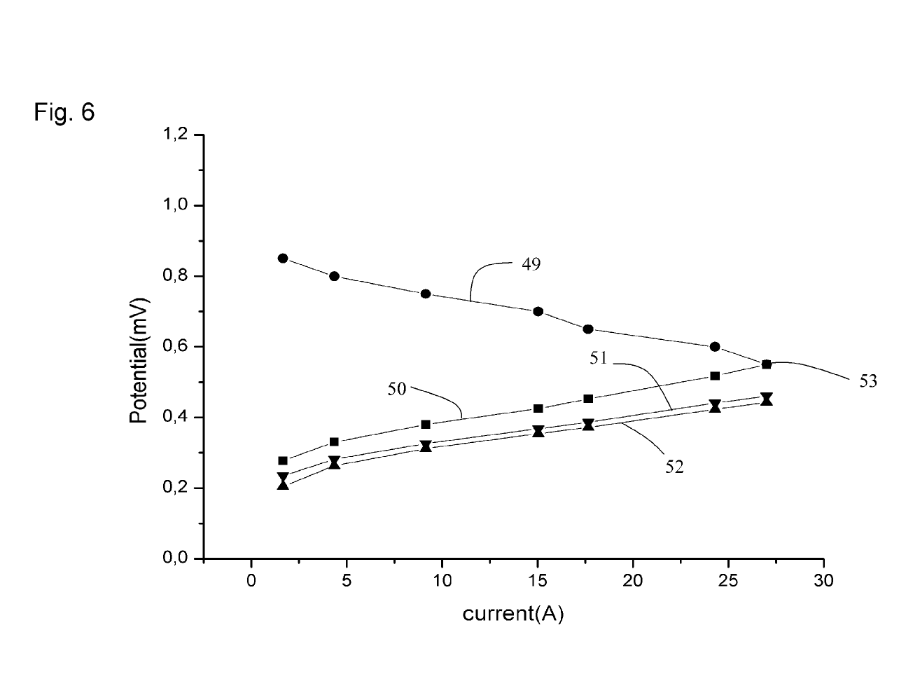

FIG. 6 shows a voltage-current-characteristic 49 of the fuel cell 34 and a voltage-current-characteristic 50 of the stack of electrolyzers 21. This stack of electrolyzers has already been used for more than 100 hours. Another voltage-current-characteristic 51 represent the operational behaviour of a new electrolyzer stack and a voltage-current-characteristic 52 depicts the operational behaviour of one of the electrolyzer 21, whose voltage-current density-characteristic 48 has been displayed in FIG. 5.

The current values displayed in FIG. 6 correspond to the current produced by the fuel cell 34. Within the electrolyzers 21 excessive hydrogen corresponding to an electrical current of 0.5 to 1.5 A has been produced. In consequence there was always a small flow of hydrogen through the fuel cell 34. Therefore, the unused hydrogen has been taken into account as system loss.

The difference between the voltage value of the voltage-current-characteristic 49 of the fuel cell and the voltage value of the voltage-current-characteristic 50 of the electrolyzer stack multiplied with the corresponding current value results in the system power of the combined stack of electrolyzers 21 and the fuel cell 34, corresponding to the system power of an arrangement such as the EDMFC 20. At a crossing point 53, the system power equal zero. At the crossing point 53 the same amount of power is needed in the stack of electrolyzers 21 for the production of hydrogen as is generated in the fuel cell 34.

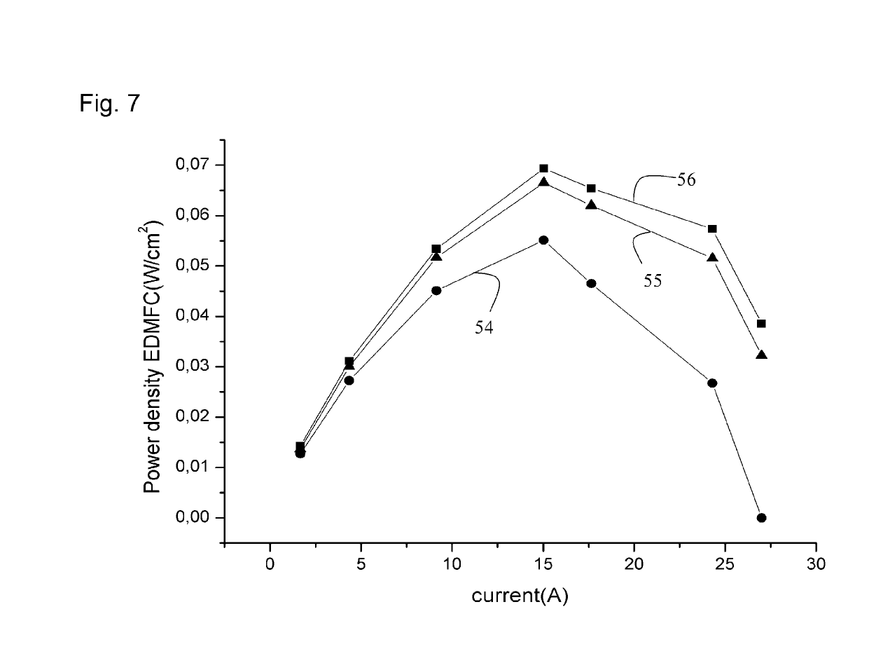

FIG. 7 shows the measured power density-current-characteristic 54 together with a calculated power density-current-characteristic 55 which results from the voltage-current-characteristic 51 in FIG. 6 and a power density-current-characteristic 56 which results from the voltage-current-characteristic 52 in FIG. 6.

The experiment showed that the system power is heavily reduced if the hydrogen is produced in the electrolyzers 21 at a temperature of 90° C. and atmospheric pressure, since the anode 37 in the fuel cell 34 is poisoned by the methanol arriving at the anode 37 of the fuel cell 34. Therefore, the hydrogen side of the electrolyzers 21 must be pressurized with an absolute pressure of 2 bar, so that the partial pressure of methanol is reduced. At an operational temperature of the electrolyzers 21 at 90° C. the build-up of an additional pressure is not only necessary due to the boiling point of methanol at 64° C. but also due to the energy lost by the water vapor produced at the operational temperature of 90° C. If the temperature of the electrolyzer cells is reduced the pressurization of the hydrogen side can be omitted since the partial pressure of methanol is lower at these reduced temperatures.

### 2. Important Aspects of the EDMFC System

### 2.1 Overvoltage Losses

The proposed approach uses two subunits namely the electrolyzer 21 and the fuel cell 34. Compared to the conventional DOFC 1 the EDMFC 20 comprises the additional electrodes 25 and 37, which are used for H₂ evolution and H₂ oxidation.

CH₃OH∥O₂ DOFC

CH₃OH∥H₂->H₂∥O₂ EDMFC

The additional cathode 25 and the additional anode 37 will introduce overvoltage losses, but since these overvoltage losses are caused by H₂ evolution and H₂ oxidation reactions, the overvoltage losses are very small. For example for a Gore™ MEA (0.5 mg/cm² PtRu anode, 0.5 mg/cm² Pt cathode) and for a current density of 0.8 A/cm², the overall overvoltage losses for both H₂ oxidation and H₂ evolution is below 20 mV at a temperature of 50° C. These values for the overvoltage losses have been measured in own experiments. By a simulation of the H₂ oxidation on Gas Diffusion Electrodes (=GDE) corresponding to the anode 37 it has been shown that the overvoltage at 0.8 A/cm² is around 10 mV. This overvoltage loss is much smaller than the overvoltage losses in DMFCs caused by methanol crossover plus cathode flooding, which could result in an overvoltage loss of more than 200 mV. Furthermore the amount of noble metal catalyst required for H₂ evolution and H₂ oxidation reactions is very small, typically below 0.4 mg/cm².

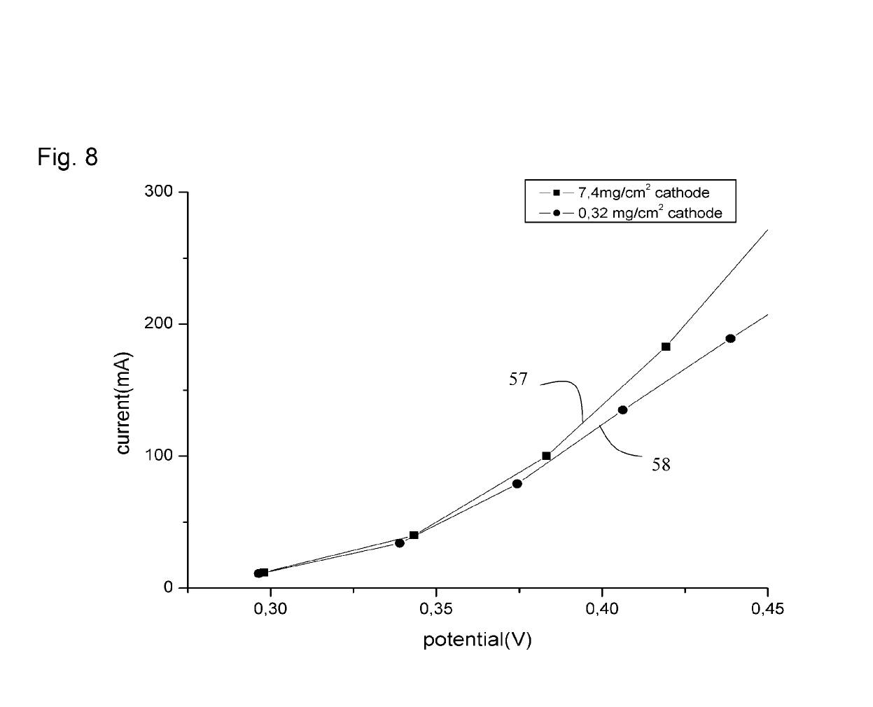

Experiments were performed to verify that increasing the cathode catalyst loading above 0.3 mg/cm² entails only a negligible further increase in the current density of the electrolyzer 21, within the relevant potential range. FIG. 8 demonstrates the effect of the cathode loading on the performance of the electrolyzer 21. FIG. 8 shows a voltage-current-characteristic 57 associated with a catalyst loading of 7.4 mg/cm² and a voltage-current-characteristic 58 corresponding to a catalyst loading of 0.32 mg/cm².

On the cathode side of the electrolyzer 21, hydrogen evolution takes place, which is generally a fast process. H₂ evolution reaction generally requires very low overvoltages for the reaction to take place and thus requires very low catalyst loadings.

The small difference between the curves shown in FIG. 8 is due to of the differences in thickness of the two MEAs. The MEA with higher cathode catalyst loading is much thicker than the MEA with lower catalyst loading. Unfortunately the bipolar plates used in this experiment are designed for thicker MEAs and so when a thinner MEA was installed, it showed much higher ohmic resistance, because the Gas Diffusion Electrode (=GDE) was not in good contact with the flow field. To counter this additional Gas Diffusion Layers (=GDL) corresponding to the gas diffusion layers 27 and 30 were inserted on both sides of the MEA so that the thickness of the overall sandwich is higher and it is pressed more against the flow field when installed in the cell and thus is in good electrical contact with the bipolar plate, which serves as a current collector and provides the flow field. But introducing these additional GDLs seems to have an effect on the mass transport, which could lead to lower currents in the high potential region for the MEA with low cathode catalyst loading. Despite the problems with the thickness of the MEAs, both behave similarly at least until 0.4 V, which is appropriate potential range for EDMFC and DMFC applications.

### 2.2 Poisoning

Poisoning of the anode 37 of the fuel cell 34 is said to occur if the current density in the fuel cell 34 keeps on decreasing with time after starting from a fresh and cleaned anode catalyst surface. The fresh and clean anode catalyst surface at the beginning is present when a pure H₂ supply is switched to a H₂ supply from the electrolyzer 21 or if a voltage pulse to low voltage, for example a 0.2 V pulse, is given to the fuel cell 34. Low voltage pulse results in oxidative removal of poisoning species and thus results in temporarily clean catalyst surface. But with time poisoning species present in the H₂ generated by the electrolyzer 21 will again poison the anode catalyst surface and bring down the current density in the fuel cell 34.

But if the current density in air fuel 34 cell supplied with H₂ from the electrolyzer 21, remains high and nearly constant for hours, then one can say that under those operating conditions poisoning is not present.

Now the extent of poisoning depends on the operating conditions of the electrolyzer, in particular temperature, fuel concentration, pressure and nature of the catalyst on the anode 37 of the fuel cell 34. At low temperature, for example ambient temperature, and low fuel concentration, no poisoning of the fuel cell 34 is seen even if Pt is used for the anode 37 and if the electrolyzer 21 is at ambient pressure. But it is highly desirable to run the EDMFC 20 at high fuel concentration as it greatly simplifies the fluid management in small systems. Similarly it is highly desirable to run the electrolyzer 21 at high temperature, as it would result in considerable catalyst savings. For example, if the temperature is raised from 25 to 90° C., the same catalyst amount gives 30 times more current density at 90° C. as compared to 25° C. Thus it is highly desirable to run an EDMFC at higher temperature and concentration in order to reduce catalyst costs and to reduce design complications. But at the conditions of high temperature and concentration, the poisoning effects also become stronger.

In a system, similar to the EDMFC 20 poisoning of the fuel cell 34 may occur since the outgoing H₂ is mixed with fuel methanol vapor and Methanol Oxidation Reaction (=MOR) by-products. Some of these components can escape from the gas separator 33 together with outgoing H₂, reaching at the fuel cell 34 and degrading the performance of the fuel cell 34. The poisoning effect can be reduced by an appropriate arrangement of the system.

For instance, the operating temperature of the electrolyzer 21 has a considerable impact on the poisoning effect. In a separated flow case, in which the outgoing H₂ produced at the cathode side is separated from the CO₂ produced at the anode side of the EDMFC 20, the operating temperature determines the amount of methanol and MOR by-products crossing over to the cathode side of the electrolyzer 21 by diffusing through the Proton Exchange Membrane (=PEM) 23. The higher the temperature, the higher is the crossover of the methanol and MOR by-products through the PEM 23. Temperature also affects the relative distribution of the MOR by-products like formaldehyde (HCHO), methylformate (HCOOCH₃), dimethoxy methane, formic acid and other by-products of the methanol oxidation reaction. The temperature of the condenser 33 also partially controls the amount of methanol and the MOR by-products vapors going to the fuel cell 34. Some of the MOR by-products are highly volatile and thus non-condensable at room temperature.

The operating pressure of the electrolyzer 21 also affects the amount of methanol and MOR by-products vapors going into the condenser tank and thus controls the concentration of these species in the condenser 33. The overall pressure in the condenser 33 again determines the amount of methanol and MOR by-products vapors going into the anode 37 of the fuel cell 34. The higher the pressure in the condenser 33, the smaller is the partial pressure of the methanol and MOR by-products vapors in the outgoing mixture containing vapors of H₂ and CO₂. Thus it limits the amount of methanol and MOR by-products vapors going to the anode 37 of the fuel cell 34.

The fuel concentration in the electrolyzer 21 affects the relative percentage of MOR by-products. For example, methanol oxidises completely to CO₂ at lower concentrations but the extent of completeness of methanol oxidation goes down with increasing concentration. This means that at high methanol concentration more and more by-products are formed rather than only CO₂ and some of these by-products are highly volatile. They diffuse through the membrane 23 of the electrolyzer 21 and also being volatile in nature they can easily escape the condenser 33 with the outgoing gas mixture into the anode 37 of the fuel cell 34. Thus, it is required to choose the parameters in order to minimize the poisoning caused by MOR by-products vapors.

The nature of by-products of any fuel oxidation reaction is important too; especially the non-condensable and volatile species are important for the poisoning effect as they will end up to some extent in the anode 37 of the fuel cell 34 and might poison it. Methanol oxidation reactions depending on working condition of temperature and concentration produce CO₂, formaldehyde, formic acid, di-methoxy methane, methyl formate and similar components. Similarly ethanol oxidation reactions produce acetaldehyde, acetic acid, ethyl acetate and similar components beside CO₂.

In the case of an electrolyzer 21 with an separated flow arrangement, in which the outgoing H₂ produced at the cathode side is separated from the CO₂ produced at the anode side of the EDMFC 20, the diffusion of MOR by-products through the membrane 23 of the electrolyzer 21 can be partially controlled by choosing an appropriate thickness of the membrane 23. This point is particularly important at high temperatures at which the diffusion rate are relatively high. Thus at high temperature, for example above 110° C., thicker membranes 23, in particular with a thickness above 50 microns can be used to limit the diffusion of volatile by-products through the membrane 23 of the electrolyzer 21.

Above all, in order to make fuel cell 34 more resistant to poisoning by methanol and MOR by-products, a methanol and MOR by-products tolerant catalyst has to be chosen on the anode 37 of the fuel cell 34. In this specific case, a methanol and MOR by-products tolerant catalyst can be defined as a catalyst whose H₂ oxidation performance is better than the performance of Pt in the presence of some amount of methanol or MOR by-product vapors in the H₂ stream under equal operational conditions. Such catalysts are binary or tertiary alloys of Pt with Ru, Re, Rh, Sn, Mo, W. In our case all studies were performed with PtRu catalyst.

The thickness of the membrane 36 in the fuel cell 34 also plays a role in controlling the poisoning of anode 37 of the fuel cell 34. The amount of O₂ crossing over from the cathode 38 to the anode 37 by diffusion might help in oxidative removal of adsorbed poisoning species on the anode 37 of the fuel cell 34.

Another way to mitigate the harmful effect of methanol poisoning on the performance of the fuel cell 34 is to periodically raise the anode overpotential of the fuel cell 34 to such a potential value at which adsorbed methanol or molecules of any other organic fuel are oxidatively removed from the catalyst surface. This potential value typically depends on the working conditions, for example temperature, nature of anode catalyst and other parameters. For example for PtRu catalyst this potential value can be in the range between 0.8 V and 0.1 V. Raising the anode overpotential can be achieved by periodically lowering voltage of the fuel cell 34. Pulsing the single fuel cell 34 voltage to lower voltages below 0.5 helps in oxidative cleaning of the anode of the fuel cell 34 and thus restores the performance of the fuel cell 34.

Periodically lowering the voltages of the fuel cell 34 results in reduced efficiency and higher H₂ consumption. To avoid this H₂ fuel loss, one can fuel starve the fuel cell 34 before applying the potential pulse to lower potentials. This would result in reduced consumption of H₂ during the low voltage pulse and thus raise the system fuel efficiency.

Air bleeding is another approach to reduce the harmful effect of methanol poisoning. This approach involves injecting small amount of air into the anode 37 of the fuel cell 34 along with H₂.

### 2.3 Self Heating

The electrolyzer 21 with I_{EL} as the single cell current of the electrolyzer 21 would have the H₂ and CO₂ fluxes:

$$\begin{matrix}{\dot{N}}_{{CO}_{2} out} = \frac{{I}_{EL}}{6 F} \\ and & ( 9 ) \\ {\dot{N}}_{{H}_{2} out} = \frac{{I}_{EL}}{2 F} , & ( 10 )\end{matrix}$$

wherein F=96485 C·Mol⁻¹ is the Faraday constant. Now the water vapor going out of the electrolyzer together with CO₂ and H₂, assuming that the outgoing gases are saturated with water vapor at that particular temperature would be:

$${\dot{N}}_{{H}_{2} Oout} = \frac{{x}_{{H}_{2} O}}{1 - {x}_{{H}_{2} O}} ( {\dot{N}}_{{CO}_{2} out} + {\dot{N}}_{{H}_{2} out} ) , {x}_{{H}_{2} O} = \frac{{p}_{{H}_{2} O}}{{p}_{total}} \qquad ( 11 )$$

p_{H2O}, the partial pressure of the saturated water vapor is given by the Clausius-Clapeyron equation:

$$ln ( \frac{{P}_{1}}{{P}_{2}} ) = \frac{Δ {H}_{V}}{R} ( \frac{1}{{T}_{2}} - \frac{1}{{T}_{1}} ) \qquad ( 12 )$$

with ΔH_{V}=40.7 kJ Mol⁻¹ is the enthalpy change of the vaporization of water and R=8.3145 J Mol⁻¹ K⁻¹.
The heat loss due to the outgoing water vapor is:

$$\dot{Q} = Δ {H}_{V} {\dot{N}}_{{H}_{2} Oout} = \frac{2}{3} \frac{{I}_{EL}}{F} Δ {H}_{V} ( \frac{{p}_{{H}_{2} O}}{{p}_{total} - {p}_{{H}_{2} O}} ) \qquad ( 13 )$$

Since the heat generated in the electrolyzer 21 is UI_{EL} where U is the potential of operation of a single cell of the electrolyzer 21 and I_{EL} is the current flowing in the single cell, the heat balance can be written as:

$$\begin{matrix}\frac{Δ Q}{Δ t} = {UI}_{EL} - \frac{2}{3} \frac{{I}_{EL}}{F} Δ {H}_{V} ( \frac{{p}_{{H}_{2} O}}{{p}_{total} - {p}_{{H}_{2} O}} ) \\ = {I}_{EL} ( U - 0.276 {JC}^{- 1} ( \frac{{p}_{{H}_{2} O}}{{p}_{total} - {p}_{{H}_{2} O}} ) )\end{matrix} \qquad ( 14 )$$

Thus self heating will occur if the term in brackets is positive since other heat loss mechanism can be neglected, which is not a bad assumption as the other hear loss mechanism such as conduction losses can be minimized by choosing an appropriate insulation.

### 2.4 The Electronic Control Unit

The distribution of power between the electrolyzer 21 and load 46 is controlled by the Electronic Control Unit (=ECU) 45. The ECU 45 can consist of voltage regulators or DC-DC step-down or step-up converters, which are generally up to 98% efficient. The ECU 45 controls the voltage efficiency of the EDMFC 20 by controlling the voltages of operation of the electrolyzer 21 and the fuel cell 37. The ECU 45 supplies electric power at appropriate voltage to the electric load 46. All other active components of the EDMFC 20 like pumps, air blowers, pressure and temperature sensors, valves and other devices are also controlled and powered by the ECU 45.

### 2.5 Passive Pressure Regulation

The pressure is self-generated in the electrolyzer 21 by the gases formed at the anode 24 (CO₂) and cathode 25 (H₂). At higher temperatures, it is required to work at elevated pressures to increase the boiling point of the methanol-water solution. So the pressure in the electrolyzer 21 is preferably maintained and regulated by passive mechanical pressure regulating valves. High pressure in the electrolyzer 21 is also required for limiting the vaporization of methanol on the side of the anode 24 and cathode 25 of the electrolyzer 21.

### 2.6 Gas-Liquid Separation

The H₂ produced at the cathode 25 of the electrolyzer 21 is separated from crossed-over methanol and water by the separator 33. The separator 33 can be orientation dependent or orientation independent, as disclosed in U.S. Pat. No. 6,869,716 B2.

### 2.7 Dead End Operation of the Fuel Cell

In order to reach high fuel efficiencies the fuel cell 34 can be operated in dead end mode instead of overstoichiometric flow mode. In this case the produced H₂ is consumed completely by the fuel cell 34. The state of the art MEAs 35 manufactured by Gore™, for instance, are able to operate in dead end mode at anode 37. Conventional fuel cells operating with H₂ supplied by metal hydride tanks (H₂ storage) or from other pure hydrogen source operate already in dead end mode.

### 3. Advantages

### 3.1 Methanol Crossover

The problem of methanol crossover of conventional DMFCs is avoided, which will save up to 40% methanol fuel and thus result in better overall energy density of the system. The EDMFC 20 avoids the problem of methanol crossover as the H₂ gas from the cathode 25 of the electrolyzer 21 can be separated from the liquid methanol using condenser or liquid gas separator assemblies. The separated methanol is then fed back to the anode 24 of the electrolyzer 21 and thus methanol (or fuel) utilization of nearly 100% can be reached. No fuel will be lost in the EDMFC 20 due to crossover. But some fuel will be lost on both side of the electrolyzer 21 due to vaporization. Also the electrochemical effect of a mixed potential at the cathode side caused by crossed-over methanol as it is the case in conventional DMFC will be overcome as well.

### 3.2 Cathode Flooding

The problem of cathode flooding due to liquid crossover is also avoided in the EDMFC 20, as the oxygen reduction reaction takes place at the separate MEA 35 in a complete gas phase as on the cathode side of a conventional PEMFC. The EDMFC scheme overcomes the cathode performance problems in DMFCs related to the cathode flooding by the crossed-over liquids (water+methanol) through the PEM permeable for liquids. In a conventional DMFC the liquids flood the cathode and thus disrupt the diffusion of oxygen to the catalyst layer, creating a mass transport barrier. In the EDMFC 20 methanol oxidation and oxygen reduction takes place in different cells, namely in the electrolyzer 21 and the fuel cell 34 respectively. The separator 33 separates the H₂ from gas-liquids mixture and the purified H₂ is then fed to the fuel cell 34. So the fuel cell 34 operates in complete gas phase. Thus the cathode 37 of the EDMFC 20 performs similarly as the cathode of a conventional PEMFC.

### 3.3 Cathode Pressure and Airflow Stoichiometry

In comparison to conventional DMFCs the EDMFC 20 requires no pressurized operation of the cathode 38 and no high flow stoichiometry. An airflow typical of a conventional PEMFC is sufficient. This simplifies the complexity of the system. In addition the electrical energy required for compressors and blowers operating at elevated pressures can be saved. The power requirement for the compressors can constitute a significant portion of up to 22% of the DMFC output depending on the pressure and air flow stoichiometry of cathode operation. Furthermore, these ancillary units have considerably increased the complexity of conventional DMFCs.

### 3.4 Heat Losses and Thermal Management

In conventional DMFCs, operation at higher temperatures causes difficulties due to the excessive water vaporization resulting in heat loss and causes a reduced cathode performance due to a reduced partial pressure of oxygen. These effects necessitate an elevated pressure at the cathode side. To achieve the elevated pressure the use of compressors is required. The heat loss due to water vaporization makes it difficult to operate the DMFC autonomously at elevated temperatures at which the electrode kinetics would improve significantly. The EDMFC 20 does not suffer from these drawbacks, since the liquid phase anodic reaction takes place in the electrolyzer 21, and gas phase H₂/O₂ electrochemical reaction takes place in the fuel cell 34. The electrolyzer 21 and the fuel cell 34 are physically separated by the separator 33 and thus water is not available in liquid form in the cathode 37 of the fuel cell 34, unlike the conventional DMFC where the water is present excessively at the cathode and where water is also vaporized leading to heat losses. But the electrolyzer 21 where the liquid phase methanol oxidation reaction takes place can be operated autonomously at high temperatures as the outgoing gas flows of the electrolyzer 21 (CO₂ and H₂) are very small compared to the air flow of a conventional DMFC (air flow with 80% N₂) and therefore can be controlled more easily. The temperature of the electrolyzer 21 is only limited by the maximum operation temperature of the electrolyte. Operating the electrolyzer 21 at higher temperatures requires overpressure. The pressure in the electrolyzer 21 in the EDMFC 20 is self-generated by the produced H₂ and CO₂ in the electrolyzer 21 but in conventional DMFC it has to be created by using compressors. The pressure in the electrolyzer 21 can be adjusted by passive pressure regulating valves.

### 3.5 Cathode Catalyst Loading

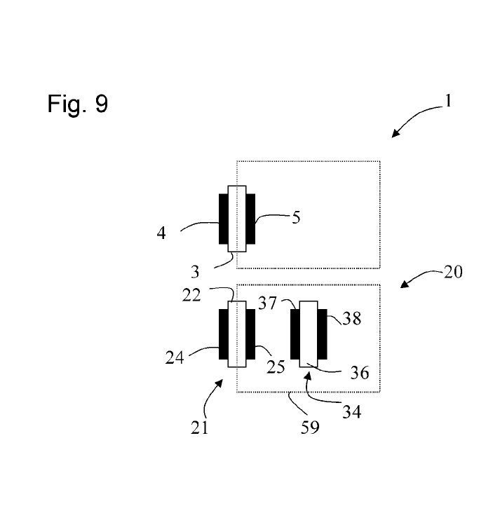

Since two additional electrodes for H₂ evolution in the electrolyzer 21 and for H₂ oxidation in the fuel cell 34 are present, an effective cathode 59 in the EDMFC 20 is composed of these two additional electrodes and additionally the oxygen reduction electrode 38 in the fuel cell 34, as illustrated in FIG. 9.

Due to the absence of methanol crossover and cathode flooding, the resulting effective catalyst loading required on the cathode side of the EDMFC 20 can be considerably lower than the catalyst loading of a conventional DMFC cathode. In the EDMFC 20 the anode (liquid phase) and the cathode (gas phase) processes are physically separated. Due to the separation the effective cathode 59 of the EDMFC 20 performs similarly as the cathode of a conventional PEMFC. In a conventional PEMFC the cathode performance is much higher than the cathode performance in a DMFC even though the DMFC typically uses considerably higher catalyst loadings than the PEMFC and drastic cathode operating conditions. The DMFC needs higher catalyst loadings and drastic operating conditions, for instance higher flows and elevated pressures to partially compensate for the harmful effects of methanol and water crossover and resulting flooding of the electrode. In the EDMFC 20 these effects no longer affect the performance of the effective cathode 59. So the catalyst loading required for the effective cathode 59 can be considerably lower than in a DMFC.

### 3.6 Anode Catalyst Loading

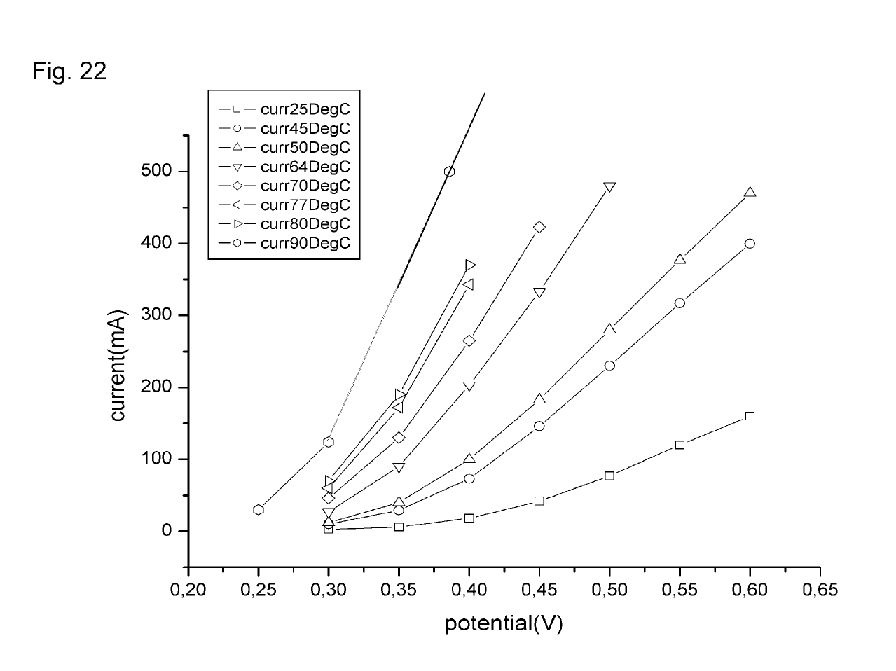

In the electrolyzer 21 of the EDMFC 20, autonomous high temperature operation is possible because of lower heat losses and pressure self-generated by the gases CO₂ and H₂. This enables easy high temperature operation of the electrolyzer 21, which allows lowering the anode catalyst loading, as the kinetics of methanol oxidation is considerably better at high temperatures, as will be explained in detail based on FIG. 22. For example the current density of the electrolyzer 21 is 5-6 times higher in the temperature range 80-90° C. than in the 50-60° C. temperature range. For this specific example there is the possibility of reducing the anode catalyst loading in the electrolyzer 21 by a factor between five and six, in comparison to a DMFC. Further increase in operation temperature of the electrolyzer 21 would result in even higher current per gram of catalyst. Better kinetics of fuel oxidation, for instance methanol oxidation, at higher operational temperatures of the electrolyzer 21 might also enable the usage of nonnoble metal catalysts. Higher current densities at higher temperature in the electrolyzer 21 would also result in higher power density of the EDMFC system.

### 3.7 System Design

The fuel cell 34 can be optimized by choosing optimized working conditions for the electrolyzer 21 and the fuel cell 34 independently. For example, the thermodynamic efficiency of the system can be optimized by choosing independently the operating voltages of the electrolyzer 21 and the fuel cell 34. In particular, the volumetric power density, the gravimetric power density (W/kg) and the costs can be optimized by choosing the right operating temperature and catalyst loading of the electrolyzer 21 and the fuel cell 34. The physically separated electrolyzer 21 and fuel cell 34 provides an opportunity to optimize different parameters independent of each other. For example, the working temperatures can be chosen independently for the electrolyzer 21 and the fuel cell 34 according to their life spans, according to heat management aspects of the EDMFC system or according to operational requirements of the system components. Furthermore, especially for portable applications the required surface temperature of the fuel cell system which should be lower than 50° C. can be much more easily achieved. In a DMFC the heat loss is much higher compared with a PEMFC caused by much higher stoichiometric air flow and heat losses by vaporized crossed over water which has to be cooled down before it exits the system. Thus the heat exchanger area in an EDMFC system will be much smaller.

In order to reach required surface temperatures in the EDMFC system, the working temperature of the fuel cell 34 can additionally be lowered. At the same time the electrolyzer 21 can perform at higher temperature. The impact of higher temperatures of the electrolyzer 21 on the surface temperature of the system can easily be reduced by using thermal insulators. By contrast, reducing the working temperature in a conventional DMFC system would reduce the electrical power output of the system much stronger compared to the reduced power output in the EDMFC 20 caused by lower operational temperatures of the fuel cell 34. Thus the EDMFC scheme allows more flexibility in designing application specific fuel cell systems compared to DMFC.

### 3.8 Compact Electrolyzer Design

The electrolyzer 21 for the EDMFC 20 where the anodic reaction of methanol oxidation takes place, can be designed very compact. Thus higher volumetric energy densities for the system can be achieved.

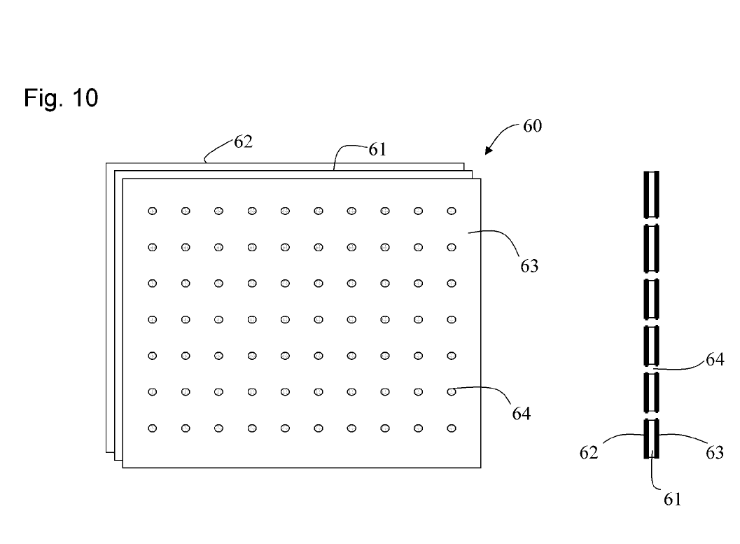

FIG. 10 shows a porous MEA stack 60, comprising an electrolyte membrane 61 with catalyst loaded gas diffusion layers 62 and 63 on both sides. The MEA stack 60 in FIG. 10 contains only a single membrane electrode assembly. But additional electrolyte membranes 61 and gas diffusion layers 62 and 63 can be added to the stack depicted in FIG. 6. The result is a MEA stack for the electrolyzer 21.

In the porous MEA stack 60 for the electrolyzer 21 methanol is not supplied through a flow field, but diffuses passively through holes 64 or pores in the MEA stack 60 to the catalyst layers, when the porous MEA stack 60 is immersed in a methanol solution. In liquid phase the mixing of H₂ and CO₂ in methanol solution does not create any problem as the solubility of H₂ in water is very small, which reduces the reoxidation current of H₂ at the anode. Furthermore the anode GDL and catalyst layer can be made hydrophilic and cathode GDL and catalyst layer can be made hydrophobic for helping to reduce reoxidation current of H2 at anode. The stack 60 may have anode (A) and cathode (C) arranged in an alternating way like ACACACACAC. Apart from this a parallel stack arrangement can also be chosen which has the anode (A) and cathode (C) arranged like ACCAACCAACCAAC. This can avoid direct contact of H₂ bubbles to the anode of the next electrolyzing unit in the porous MEA stack 60, but would require parallel voltage connection. The final gas output of the electrolyzer 21 would be a mixture of CO₂ and H₂ which is fed to the anode 37 of the fuel cell 34. This approach will help in achieving very small cell pitch, as no bipolar plate with flow field is required. A small steal grid or some other porous conducting layer can be used as a current collector. Such an approach would be especially beneficial for miniaturizing fuel cell based power supplies. In order to get an orientation independent gas supply from this electrolyzer type additional gas liquid separators have to be installed at various faces of the electrolyzer 21 compared to a flowfield design.

### 3.9 Power Recovery

The methanol oxidation reaction produces CO₂ on the anode side and H₂ on the cathode side, which generates pressure. This self generated pressure and the gas flows can be used for passive pumping of fluids in an EDMFC system or to recover the energy in form of electrical energy by using suitable conversion devices. Concepts for such devices are disclosed in US 2003/0095872 A1.

3.10 Electrolyzer Working with Various Electrolytes

Because of the physical separation of anodic and cathodic processes in the EDMFC 20 the electrolyzer 21 can work with other electrolytes than the fuel cell 34, for example acidic or alkaline, high temperature or low temperature electrolytes. In a conventional DMFC flexibility in choosing different anode and cathode electrolytes and operations at different temperatures of anode and cathode are not available.

Solid High Temperature Electrolyte

Use of electrolytes which can work at temperatures up to 180-200° C., for example composite Nafion membrane, composite sulfonated polyetheretherketone (sPEEK)-ZrP membranes, PBI based electrolyte membranes, would result in considerable noble metal catalyst savings.

Electrolyzer Based on Liquid Electrolytes

Other types of electrolytes which could also contribute towards system miniaturization can be liquid electrolytes. Because the cathode side of the electrolyzer 21 performs also in liquid phase, one can use micro/nano porous electrical insulating matrices as separator between anode 24 and cathode 25 which are filled with liquid electrolyte like sulfuric acid, triflic acid, phosphoric acid and other materials. This allows the electrolyzer 21 to perform at high temperatures above 120° C., where Nafion can no longer be used. Since the kinetics improves at higher temperatures, it would be possible to save significant amounts of catalyst due to the operation at higher temperatures. The output of this kind of electrolyzer 21 can be separated gases as from electrolyzers with bipolar plate stack architecture or a mixture of CO₂ and H₂. Electrolyzer design with mixed gas output provides a potential for miniaturizing the electrolyzer 21 and thus contributes to miniaturize the overall EDMFC system.

Polymer Alkaline Membranes

Alkaline media offers better kinetics for major fuel cell processes. Progress in solid polymer alkaline membranes would make it easier to use them in fuel cells. EDMFC can also utilize the advantage of better kinetics by using these membranes in the electrolyzer 21. This can result in lower overvoltage losses in anodic processes of the electrolyzers 21.
3.11 Electrolyzer with Mixed Output

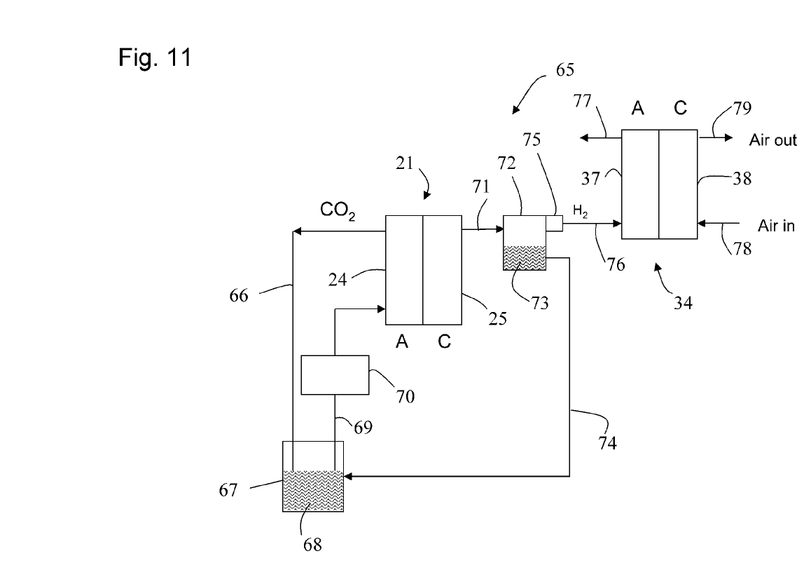

The electrolyzer 21 can be used in separated flow mode or mixed flow mode. FIGS. 11 to 13 show different configurations of an EDMFC system. Each could be chosen according to a particular requirement for any EDMFC system. Separated flow electrolyzer 21 represent the case when the anodic and cathodic flows go to separate condenser/gas-liquid separators. In this case the H₂ output of cathode of the electrolyzer 21 is fed to the fuel cell 34.

FIG. 11 shows a block diagram of an EDMFC 65 with a separated flow. In the EDMFC 65 the anode 24 of the electrolyzer 21 is connected to a conduit 66 conducting the CO₂ produced in the anode 24 to a fuel tank 67 containing fuel 68, which is a mixture of methanol and water. The fuel 68 can be conducted back to the electrolyzer using a conduit 69 and a fuel pump 70. The cathode 25 of the electrolyzer 21 is further connected to a conduit 71, which leads to a condenser 72. The condensate 73 is fed back into the fuel tank 67 via a conduit 74. The hydrogen passes through a pressure regulating valve 75 and arrives at the anode 37 of the fuel cell 34 through conduit 76. The hydrogen, which is not used in the anode 37 can leave the anode of the fuel cell 34 by a conduit 77. For the sake of completeness it should be mentioned, that air is supplied to the cathode 38 of the fuel cell 34 via a conduit 78 and the remaining air together with the water produced in the fuel cell 34 can leave the fuel cell 34 through a conduit 79.

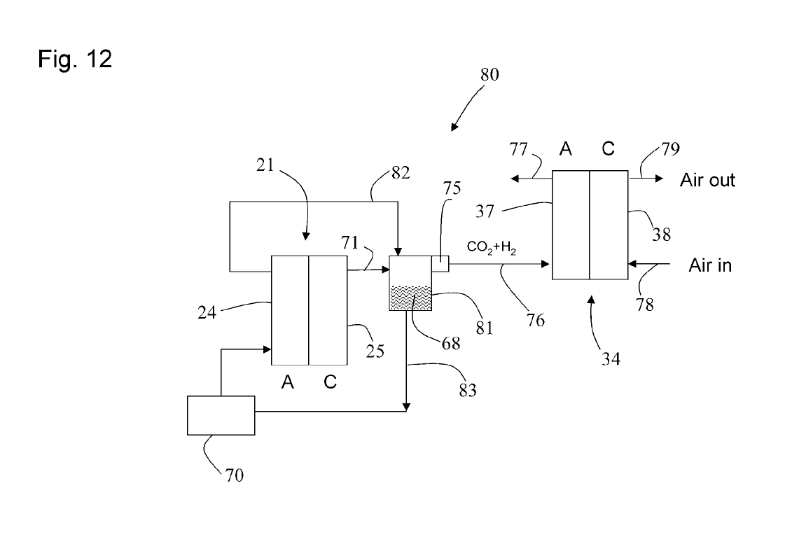

FIG. 12 shows a block diagram of an EDMFC 80 with a combined flow of hydrogen and CO₂. In the embodiment of FIG. 12 the CO₂ produced in the anode 24 is conducted to a condensating fuel tank 81 by an conduit 82. The fuel tank 81 is also connected to cathode 25 of the electrolyzer 21 via conduit 71. The fuel 68 within the fuel tank 81 is fed back into the anode 24 through conduit 83 which is provided with the fuel pump 70. H₂ and CO₂ can pass through valve 75 and conduit 76 and reach the anode 37 of the fuel cell 34.

In mixed flow electrolyzer 21 anodic and cathodic flows are fed to a common condenser/gas-liquid separator tank. The output of the electrolyzer 21 typically consists of H₂ (75%) and CO₂ (25%). The mixed flow electrolyzer 21 allows to eliminate one condenser/gas-liquid separator tank, which could be very useful for designing compact EDMFC systems.

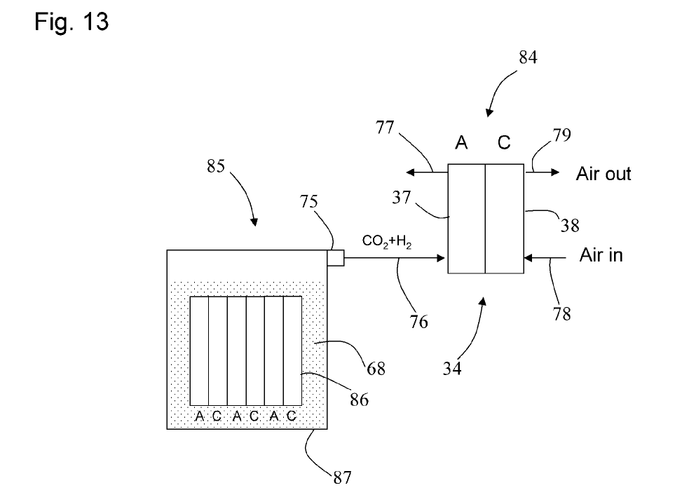

FIG. 13 shows a mixed flow EDMFC 84 with a modified electrolyzer 85. In this electrolyzer 85 an electrolyzer stack 86 is kept in a fuel tank 87 and the fuel 68 can diffuse passively or can be pumped into the anodes of the individual cells of the electrolyzer stack 86. But the liquids from the anode and cathode side of the electrolyzer stack 86 remain in the fuel tank 87. Only gases (CO₂+H₂) leave the fuel tank 87 via the valve 75 and conduit 76. For orientation independence a gas-liquid separator membrane can be used with several outlets disposed on different sides of the fuel tank 87.

### 3.12 Pulsing the Electrolyzer to Lower Potentials

Continuous polarization of the electrolyzer 21 or 85 at a certain potential for extended periods of time might result in faster degradation rates of anode catalyst activity. Periodical pulsing of anode catalyst to lower potentials helps in partially regenerating the activity of the catalyst. So the operation of the electrolyzer 21 or 85 with periodical short pulses to lower potentials, for instance 0 V or even <0 V might slow down the degradation in catalyst activity.

### 4. Electronic Circuit and Power Management in EDMFC

### 4.1 Simplified Electronic Circuit

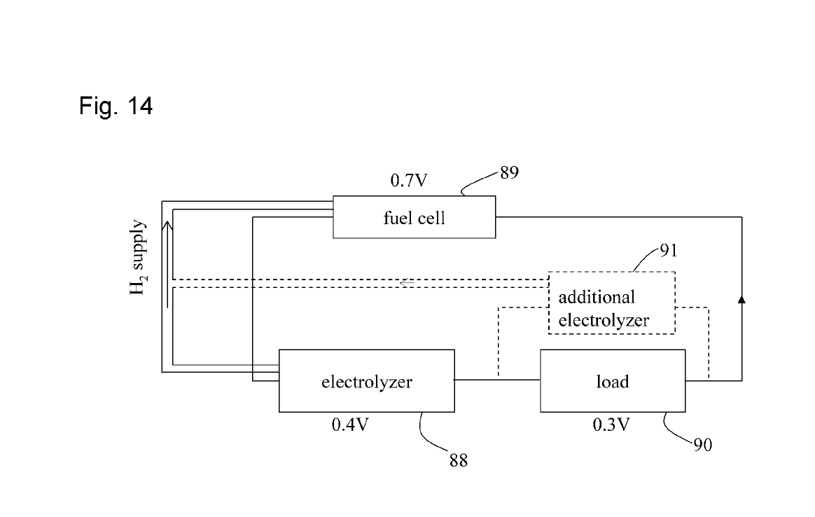

FIG. 14 illustrates in a simplified way how the voltage and current can be distributed between the main components of the EDMFCs 20, 65, 80 and 84, namely an electrolyzer 88, fuel cell 89 and load 90, in an ideal case of no hydrogen loss in the system. For example if hydrogen is being produced by a electrolyzer 88 at 0.4 V (a typical anode over voltage for a conventional DMFC) with a current I, and if the current I is fed in the fuel cell 89 running in dead end mode at 0.7 V, which is a typical cell potential for PEMFC, 0.3 V*I remain as power output. The voltages at which the electrolyzer 88 and fuel cell 89 are operated, determines the overall voltage efficiency of the EDMFC system.

In a non ideal case of some H₂ loss in the system, the simplified circuit has to be designed differently.

FIG. 14 also shows an EDMFC simplified series electronic circuit in a practical case with H₂ loss. An additional electrolyzer 91 compensates for the H₂ loss in the system and thus makes sure that this series circuit runs properly. Single lines depict the electrical wire and double lines depict the conduits and pipes for the H₂ flow.

In a practical system, the H₂ losses in the pipes connecting the electrolyzer 88 and the fuel cell 89 and in the H₂/air flow field of the fuel cell 89 will result in non-functioning of the simplified series electronic circuit without the components depicted in dashed lines. But if an additional appropriate size electrolyzer 88 designed to produce H₂ equivalent to H₂ losses in the system is connected in parallel to the fuel cell 89 or load 90, then this series circuit can work. Furthermore this circuit can regulate the potential of the fuel cell 89 and the electrolyzer 88 according to the power demand of the load 90. But generally the series electronic circuit will work as long as the H₂ losses are compensated. This means that the H₂ loss compensating electrolyzer 91 do not necessarily need to be connected to the main circuit. For example it could be powered by a regulated voltage from a ECU, which can assess H₂ loss in real time and accordingly give just enough power to the loss compensating electrolyzer 91 to produce the required H₂. Finally this circuit will help in eliminating the requirement of lossy DC-DC converters, which might be otherwise needed to supply the regulated voltages to electrolyzer 88.

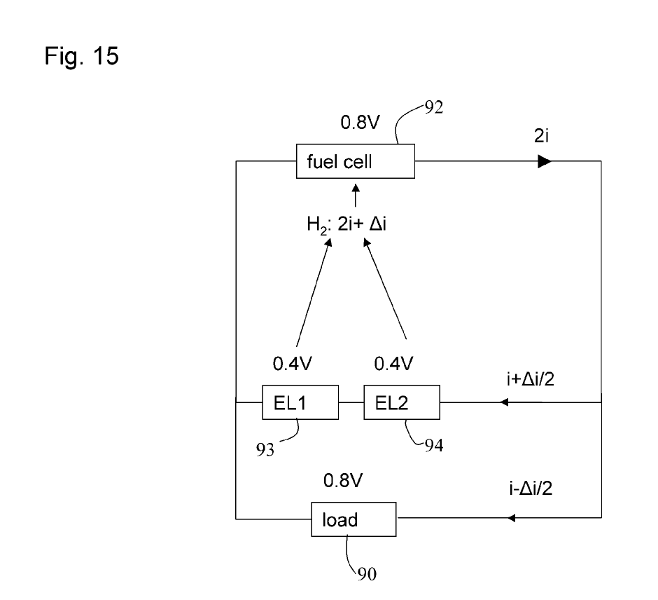

FIG. 15 shows an alternative circuit for power distribution. FIG. 15 shows a circuit where a fuel cell 92, two electrolyzer cells 93 and 94, also marked EL1 and EL2, and an electric load 90 with appropriate current voltage characteristics are connected in parallel. Now for example if there is a loss of H₂, equivalent to Δi, in the system, then one can adjust the electrical operational points of the electrolyzer cells 93 and 94 and the load 90, in such a way that the current is distributed as shown in FIG. 15. This ensures that the electrolyzer cells 93 and 94 produces H₂ equivalent to 2i+Δi and the electrical current in the circuit is 2i. The H₂ equivalent to Δi is lost in the system. This Δi can be any value depending on the system. But for an efficient system it has to be minimized.

The two simplified circuit designs suggested in this section are meant only to illustrate the distribution of current and potential in an EDMFC system, which is generally controlled by the electronic control unit 45.

The EDMFCs 20, 65, 80 and 84 including air blowers, pumps or other electrical components, can also be designed without the ECU 45 by just connecting the components and the electric load in appropriate combinations of serial and parallel circuits.

4.2 EDMFC with Various Electronic Circuits and H₂ Supply Configurations

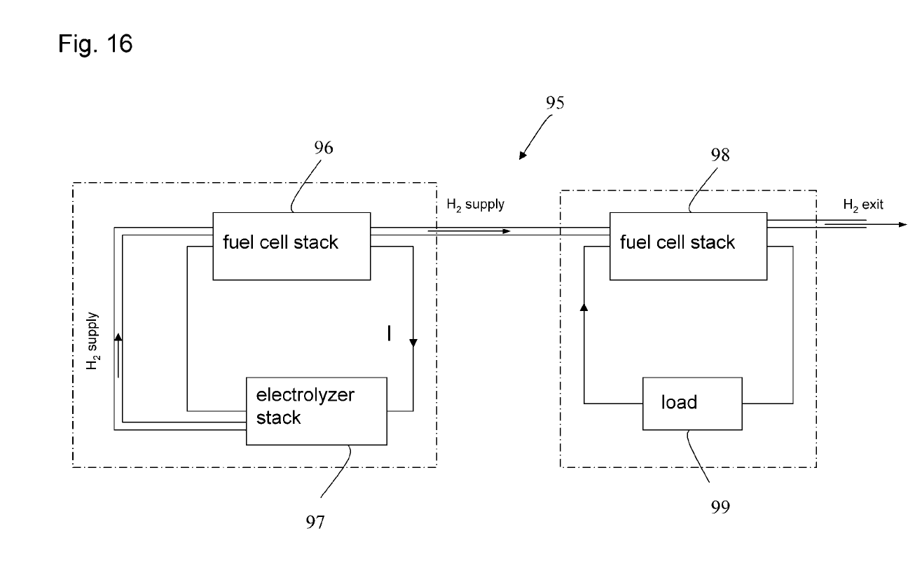

As depicted in FIG. 16, an EDMFC can also be designed such, that there is a fuel cell or a fuel cell stack 96 connected with an electrolyzer stack 97. The working points of the electrolyzer stack 97 and fuel cell stack 96 with appropriate electronic circuit can be chosen in a way that more H₂ is produced in the electrolyzer stack 97 than is consumed in the fuel cell stack 96. The excess of H₂ is then fed to another fuel cell or fuel cell stack 98. The power produced in this fuel cell stack 98 can be supplied to an external electric load 99. In this case, the circuit of the fuel cell stack 96 with the electrolyzer stack 97 acts as self powered hydrogen generator. By choosing an appropriate number of cells in the fuel cell stack 96 and in the electrolyzer stack 97 and by choosing an appropriate active area of each cell as well as suitable properties of the MEAs and suitable operating conditions, the working points of the electrolyzer stack 97 and fuel cell stack 96 can be matched to produce excess of hydrogen. The excess of hydrogen is then fed to the other fuel cell stack 98 to power the external load 99. This circuit can run without any additional regulation, in particular without using the ECU 45. This will spare energy losses in the ECU 45 and can reduce the costs of the EDMFC system.

FIG. 16 shows a scheme where the left block composed of the fuel cell stack 96 and the electrolyzer stack 97 works as a hydrogen generator and the right block is used to consume the H₂ thus produced to generate electric power for the electric load 99. The electrical connections are shown as single solid line and the H₂ gas flows conduits are shown by tubes. FIG. 16 depicts a way of H₂ distribution, in which the two fuel cell stacks 96 and 98 are connected in series with respect to the H₂ gas flow.

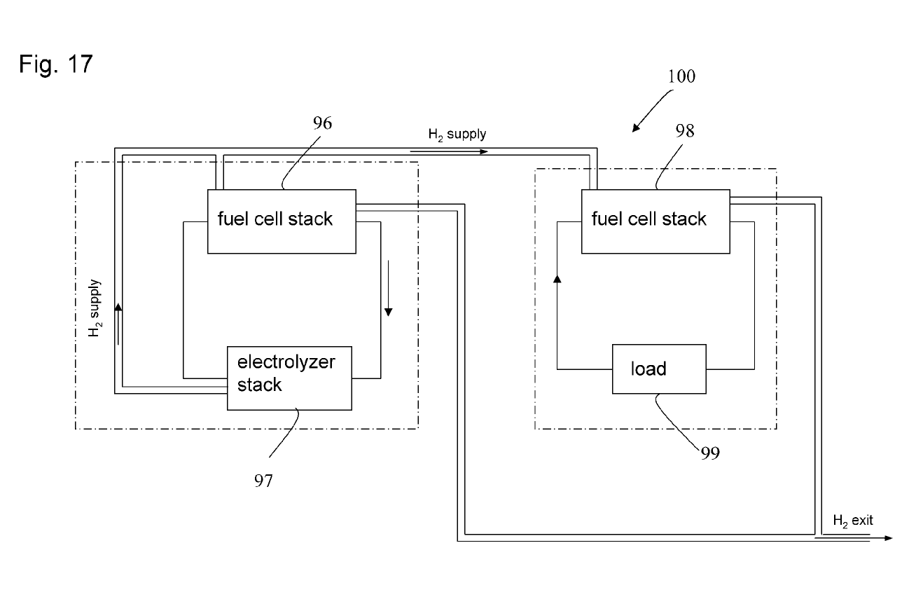

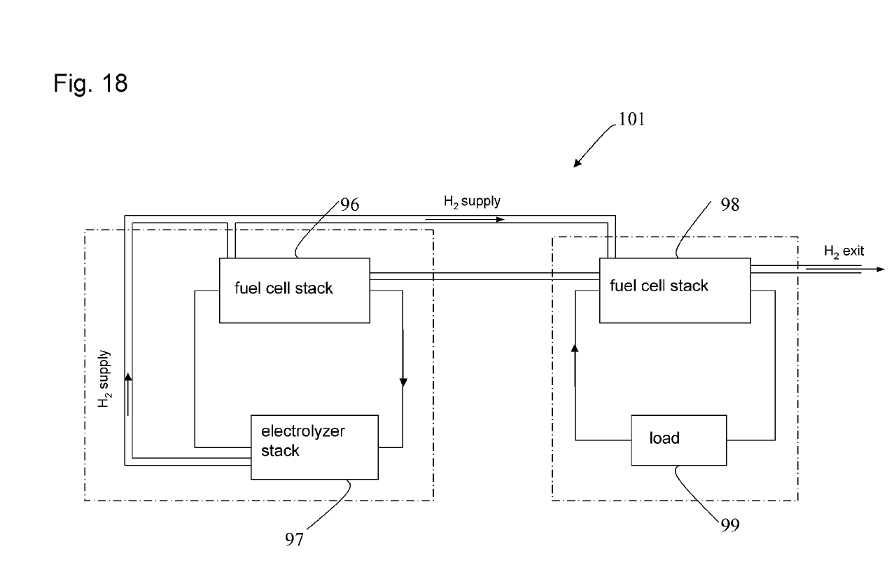

FIG. 17 shows a EDMFC 100 with a parallel distribution of H₂ from the electrolyzer stack 97 to the two fuel cell stacks 96 and 98. In the case of a parallel distribution of H₂ the H₂ output of the first fuel cell stack 96 may contain some unutilized H₂. FIG. 18 shows a EDMFC 101 with a parallel H₂ flow scheme with the output of the first fuel cell stack 96 inserted into the second fuel cell stack 98.

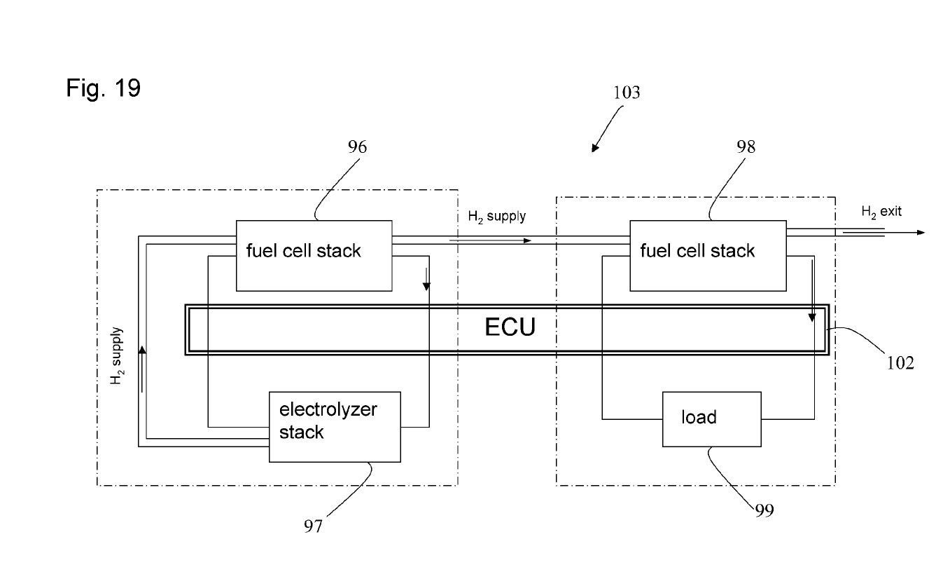

In equilibrium conditions when the electrical characteristics of all components, in particular fuel cell stack 96 and 98, electrolyzer stack 97 and load 99 are fixed, the EDMFCs 95, 100 and 101 based on the circuits and H₂ flow configurations described in this section can work without any regulation by the ECU 45. But in case of changing power requirement of the electric load 99 or any other changes in electrical characteristics of the fuel cell stacks 96 and 98 as well as electrolyzer stack 97, an active regulation by an ECU 102 will be needed for a EDMFC 103, as depicted in FIG. 19.

### 4.3 Scheme of Electrical Power Management in EDMFC

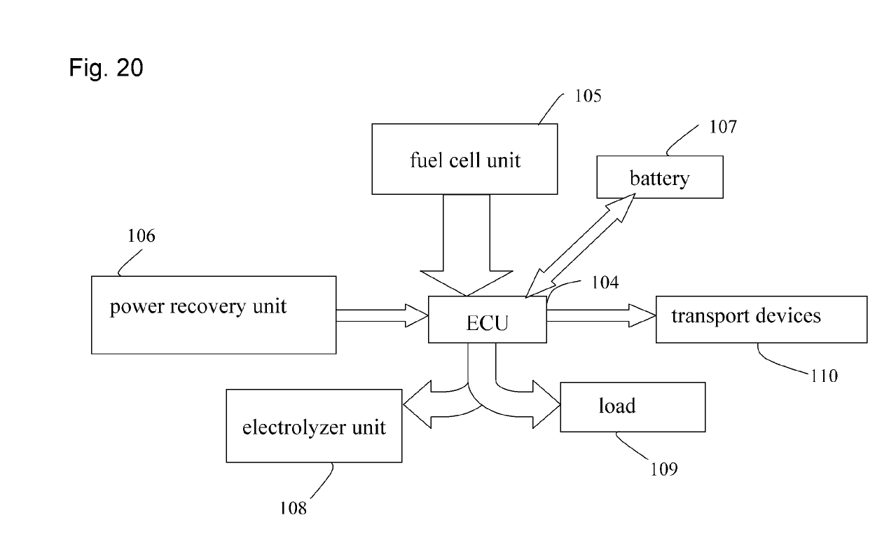

FIG. 20 shows a schematic view of the power distribution in an EDMFC-system. For real time power management one may require proper voltage and power regulation units like an ECU 104 to run the system.

According to FIG. 20 the ECU 104 is supplied with power from a fuel cell unit 105, which might be a single or a plurality of fuel cell stacks. The ECU 104 receives also power from a power recovery unit 106, which recovers power from pressurized gases. A battery 107 might be used for energy storage. The energy received by the ECU 104 is distributed among an electrolyzer unit 108, a load 109 and a number of ancillary units 110 such as pumps and blowers.

### 5. EDMFC System Design

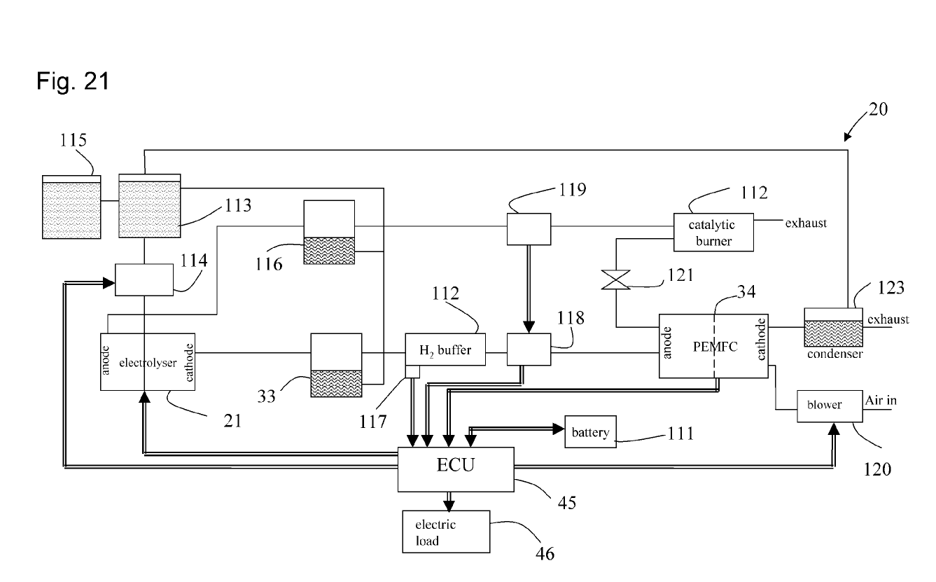

In FIG. 21 the EDMFC 20 is shown in more detail.

To start up the system the ECU 45 has to supply the electrolyzer 21 with electrical power from a battery 111 or ultra capacitor or any other electrical energy source. Alternatively a H₂ buffer tank 112 can also help in starting the whole system by supplying the stored H₂ to the fuel cell 34. The EDMFC 20 can also be designed such, that the fuel cell 34 is fed by a mixed H₂ and CO₂ output of the electrolyzer 21. The EDMFC 20 can also be designed such that the EDMFC 20 can be switched between mixed and separated flow operation.

The methanol water mixture from a fuel tank 113 is delivered by a fuel pump 114 to the electrolyzer 21. The methanol in the fuel tank 113 is provided by a fuel reservoir 115. In the presence of methanol and by applying a certain voltage at the electrolyzer 21 the methanol will be oxidized to H₂ and CO₂. The H₂ will be produced at the cathode side, the CO₂ at the anode side of the electrolyzer 21 (equations 3 and 4). The higher the applied voltage at the electrolyzer 21, the higher is the current density and the H₂ production increases correspondingly. The maximum voltage will be limited in case of using Ru containing catalyst to approximately 0.8 V in order to avoid Ru-oxides formation. To achieve reasonable currents and system efficiencies the voltage applied to the electrolyzer 21 should be between 0.3 V and 0.5 V but the voltage can also exceed these limits. The humid CO₂ and H₂ gas which exit the electrolyzer 21 will be separated from liquid water or water methanol mixtures in the gas liquid separator 33 and 116. The separated liquids will be conducted back to the fuel tank 113 by pumps or by using passive pumping system driven by the self generated pressure. The H₂ buffer tank 112 can be filled up to a certain pressure. By using a pressure sensor 117 together with the ECU 45 the H₂ production in the electrolyzer 21 can be controlled. The H₂ buffer tank 112 will help in smoothening out fluctuations in the performance of the electrolyzer 21 and fuel cell 34. The H₂ buffer tank 112 could also be used as a source of H₂ for starting up the EDMFC system.

Then the H₂ passes a power recovery module 118 which can recover the energy of the compressed gas. The recovered energy can be converted to electrical energy or can be used as mechanical energy. For example, the recovered energy might be directly used to run blowers for producing the air flow on the cathode side of the fuel cell 34. On the CO₂ side energy recovery can be done in the same way using a power recovery module 119. In case of an electrical energy conversion the recovered electrical power is fed to the ECU 45 which will distribute it to the system components and the load 46.

The H₂ enters then the fuel cell 34 together with the air or oxygen that enters the cathode side of the fuel cell 34 by self diffusion or is supplied via blowers 120 into the cathode. H₂ and O₂ will react to water producing electrical power. The fuel cell 34 can be run in dead end mode on the H₂ side. To achieve a better dead end performance one need a valve 121 at the outlet of the anode 37 which opens from time to time in order to purge the anode 37 from gases other than H₂. The outgoing H₂ gas is inserted into a catalytic burner 122 before being released into the environment. After passing the power recovery module 119, the CO₂ gas which carries methanol vapors will also be inserted into the catalytic burner 122 in order to oxidize the methanol before exiting the system.

The catalytic burner can be replaced by an electrochemical membrane electrode assembly (MEA) which can oxidize H₂ and methanol in the outgoing exhaust gases at its anode and thus H₂ produced at the cathode of the MEA can be recycled back to the fuel cell. This MEA would require electrical power from the ECU, but would help in recycling the outgoing fuel, for example H₂ and methanol vapours. Another option for cleaning the exhaust gases from H₂ and methanol vapours is to conduct the exhaust gases through a fuel cell running at short circuit or a low cell voltage.

The exhaust gas from the cathode side of the fuel cell 34 can finally be inserted into a condenser 123. The condensed water can be recovered and inserted back to the fuel tank 113 in order to achieve the desired methanol dilution. By recovering the produced water the system can run without adding additional water to the system.

The electrical power produced by the fuel cell 34 is higher then the electrical power needed in the electrolyzer 21 for producing the desired H₂. For example, when the fuel cell 34 runs at 0.7 Volt and the electrolyzer 21 at 0.4 Volt, then an electrical power of 0.3*I can be consumed in the electric load 46 (FIG. 14). The electrical power distribution between fuel cell 34, electrolyzer 21, electric load 46, battery 111, pumps 114, blowers 120, sensors 117 and valve 121 will be controlled by the ECU 45. Furthermore, the regulations of temperature, pressure, flow, concentration of methanol-water mixture can also be controlled by ECU 45. By means of the ECU 45 the voltage of the fuel cell 34 and the electrolyzer 21 can be chosen independently. Thus the efficiency can be adjusted. A loss of H₂ in the system in dead end or continuous flow mode requires that the ECU 45 compensates the lost hydrogen by supplying additional electrical power to the electrolyzer 21. These losses will reduce the overall power output of the system.

The EDMFC system design described in this section is only one example for realizing the EDMFC 20. There can be many other ways of designing an EDMFC system.

In particular, an EDMFC system can also be designed with no or very few system components. For example, an EDMFC made up of a passively fed electrolyzer 21 without pumps for liquids and a self breathing fuel cell 34 is also feasible.

### 6. Calculations for a Comparison Between DMFC and EDMFC

### 6.1 Physical Properties

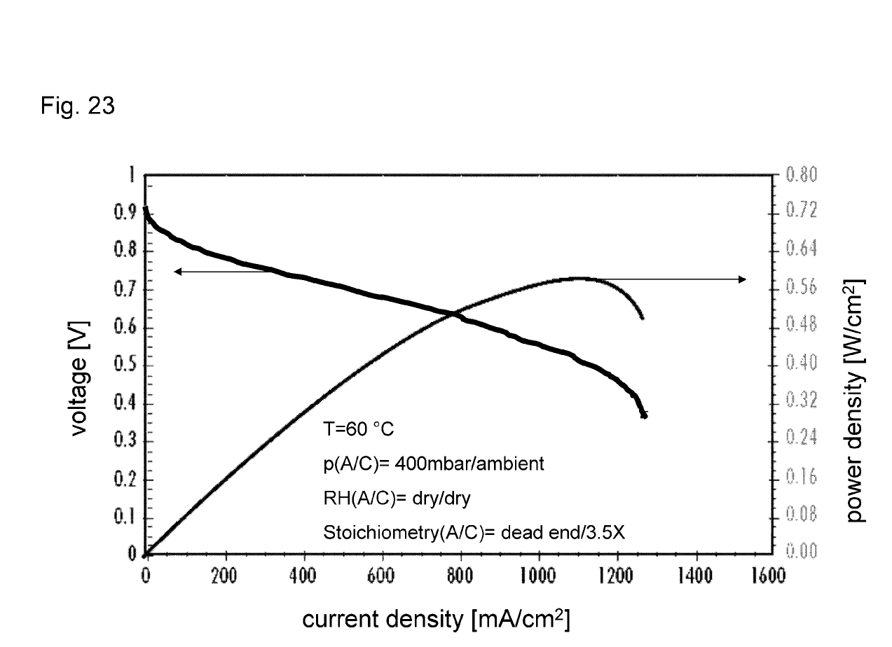

Table 1 contains the results of some calculations regarding a comparison between the physical properties of a conventional DMFC and a EDMFC under different operating conditions. The data for the DMFC are taken from: DOHLE, H.; SCHMITZ, H.; BEER, T.; MERGEL, J.; STOLTEN, D.: Journal of Power Sources 106 (2002) 313-322. The EDMFC data are calculated from the U-I characteristics of an electrolyzer in FIG. 22 and of a fuel cell in FIG. 23. The data of FIG. 22 are data regarding Gore™ MEA. It is further assumed, that the electrolyzer 21 runs at different temperatures, whereas the fuel cell 34 is running at 60° C. in a dead end mode under ambient conditions and λ(air)=3.5. For calculating the value listed in Table 1 an area of 1 cm² of the electrolyzer 21 with a catalyst loading of 4.2 mg/cm² PtRu at the anode side and 0.5 mg/cm² Pt at the cathode side has been assumed. Then FIG. 22 has been used to look up the current, which can be expected for some particular operating voltage and temperature. The equivalent H₂ from that current is assumed to be consumed in the fuel cell 34 at a particular temperature and cell voltage. Taking standard performance characteristics of fuel cells 34 the active area and catalyst needed to support that much current is calculated. The system power P_{syst} produced under these conditions is also calculated. Then the DMFC active area and catalyst loading needed to achieve the same power is calculated for different conditions of temperature, cathode pressure and air flow.

### Explanation of Some Examples from Table 1

### Example 1

The performance at temperature 77° C. is calculated. The data for the performance of the DMFC are taken from the reference cited above. The electrolyzer data are taken from our measurements which are shown in FIG. 22. The 1 cm² area of the MEA 22 of the electrolyzer 21 at 77° C. with 4.2 mg/cm² PtRu results in a current density of 343 mA/cm² at 0.4 V. Then H₂ corresponding to this current is fed to the fuel cell 34. Taking the data from FIG. 23, a 2.3 cm² area of the MEA 35 is required, when the fuel cell 34 operates at 0.8 V. If the fuel cell voltage is at 0.8 V a voltage amounting to 0.5 V can be applied to the external load 46. Since 1 cm² of the MEA 22 the electrolyzer will result in a current of 343 mA and since the external load is supplied with a voltage of 0.4 V the total power supplied to the external load 46 is 137 mW.

Then the area and catalyst loading needed for same power is calculated for the DMFC. A DMFC operating at 77° C., with ambient pressure cathode, has a power density of 32 mW/cm², with a catalyst loading of 6.2 mg/cm². So for 137 mW, a MEA area of 4.28 cm² and overall 26.5 mg catalyst loading for the DMFC is needed. However, the total loading catalyst for the EDMFC resulting in the same power output amounts only to 7 mg.

The calculations for further examples 2 to 10 are listed in the Table 1. Generally operating the electrolyzer 21 at higher temperature and at higher current densities and the fuel cell 34 at higher cell voltages and lower current densities minimize the catalyst needed for EDMFC system.

### 6.2 Calculations for a Power Source of 50 W

DMFC from FZ Jülich published data:

### Operating Parameters:

50 mW/cm² at 0.34 V
3.9 mg/cm² PtRu unsupported catalyst at anode
2.3 mg/cm² Pt unsupported catalyst at cathode
1.5 bar cathode with airflow stoichiometry 3-4.
70° C. operation
For 50 W total power 1000 cm² of MEA active area is required, which result in a catalyst loading of 1000×(3.9 mg PtRu+2.3 mg Pt)=3.9 g PtRu+2.3 g Pt

### Cost Calculation:

3.9 g*52 $/g (for PtRu)+2.3 g*71 $/g (for Pt)=366 $

Total active MEA area needed in DMFC: 1000 cm²

EDMFC Scheme:

Operating parameters: Single cell voltage: 0.35 V
Electrolyzer 21: 0.4 V at 90° C., with 4.2 mg/cm² PtRu at anode and 0.5 mg/cm² Pt at cathode and 500 mA/cm².
Fuel cell 34: 0.75 V at 300 mA/cm², Gore™ MEA 58 series data at 60° C., dead end anode and ambient cathode with dry air stoichiometry 3.5:0.5 mg/cm² PtRu at anode and 0.5 mg/cm² Pt at cathode.
For 50 W at 0.35V, the current required is 143 A.
For a current of 143 A with the abovementioned electrolyzer, 286 cm² of active area is needed resulting in 286*(4.2 mg PtRu+0.5 mg Pt)=1201 mg PtRu+143 mg Pt
For a current of 143 A at above mentioned conditions, 477 cm² of MEA active area is needed in the fuel cell.

### =477*(0.5 mg PtRu+0.5 mg Pt)=

238 mg PtRu+238 mg Pt Total catalyst required in EDMFC: 1.439 g PtRu+381 mg Pt

### Cost Calculation:

1.439 g*52 $/g+0.381 g*71 $/g=101.8 $

Total active MEA area needed in EDMFC: 763 cm²

It is important to note that the EDMFC 20 requires 25% less MEA active area and 3.6 times less catalyst costs for this configuration. The EDMFC 20 would also have fuel utilization up to nearly 100%.

### 6.3 Comparison of Relevant Parameters of DMFC and EDMFC

For comparing the EDMFC 20 with a DMFC system, a conventional DMFC system was characterized in order to find out its operating parameters. Table 2 lists some of these parameters. Most important of these parameters are voltage efficiency, fuel efficiency, system efficiency and total efficiency.

Voltage efficiency is defined as the ratio of single cell DMFC operating voltage to the maximum possible thermodynamic voltage, which is around 1.2 V for a DMFC single cell. Voltage efficiency for any electrochemical oxidation reaction indicates the ratio between produced electrical and heat energy. For example a voltage efficiency of 0.46 means that 46% electrical energy and 54% heat energy is produced. In a DMFC, a considerable amount of methanol fuel is lost because of methanol crossover from anode to cathode. This crossed-over methanol is burnt at the cathode. Fuel efficiency indicates the ratio of methanol which resulted in production of electrical power to total methanol input into the DMFC system. Thus a fuel efficiency of 0.54 indicates that 46% of the fuel is lost because of methanol crossover in a DMFC. System efficiency indicates the power consumption of the peripheral devices such as air blowers and pumps to the total power produced by the DMFC stack.

Total efficiency is the product of voltage, fuel and system efficiency. Thus after measuring all these parameters for a DMFC system, appropriate values of parameters were chosen for the EDMFC 20 in order to obtain the same total efficiency of 0.19. It should be recognized that the EDMFC 20 has a fuel efficiency of nearly 1 since hardly any fuel is lost. Thus the voltage efficiency of the EDMFC 20 can be lowered while still keeping the total efficiency at 0.19. Low voltage efficiency means a lower single cell voltage, at which generally current and power density is several times higher. This factor, along with self-sustained high temperature operation of the electrolyzer 21 and much improved cathode operation in the fuel cell 34 helps in achieving much more power per gram of noble metal catalyst. Similarly the stack power density of the overall EDMFC system is also increased by a factor of 2-3. Table 2 shows that a DMFC system with a total energy conversion efficiency of 0.19 provides 5-15 Watts of power per gram of catalyst, but an EDMFC system with the electrolyzer 21 running at 110° C. and the fuel cell 34 running at 60-80° C., having the same total energy conversion efficiency of 0.19, provides 80-120 Watts of power per gram of noble metal catalyst. Thus the potential of saving noble metal catalyst is considerable in an EDMFC 20 in comparison to a DMFC.

### 7. Experimental Results

In the following some experimentally results are described in which various approaches are used to completely eliminate or significantly reduce the effect of methanol and MOR by-products poisoning.

The cases 1 to 3 refer to a separated flow arrangement as shown in FIG. 11, whereas cases 4 and 5 refer to a mixed flow arrangement as depicted in FIG. 12.

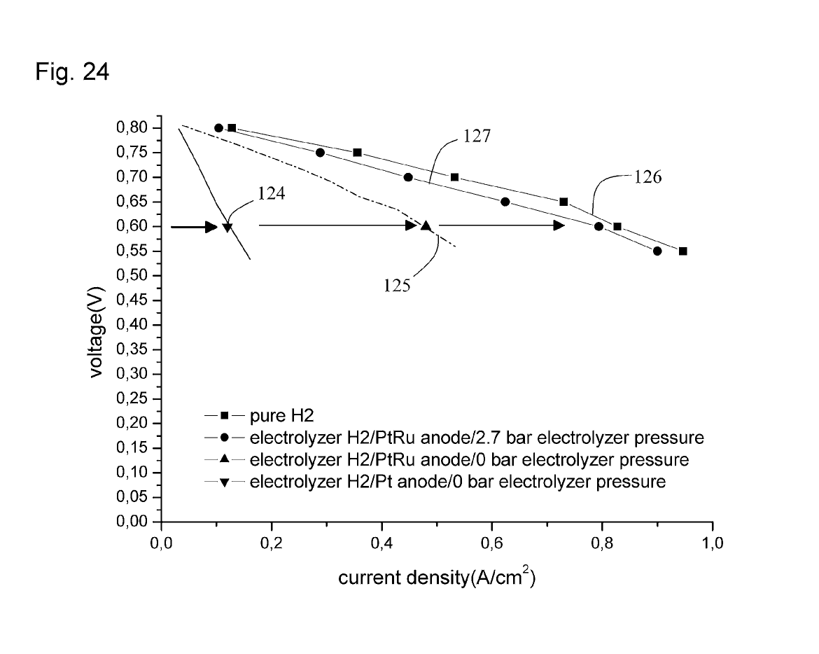

Case 1: FIG. 24 shows some experimental data which demonstrate the individual effect of individual parameters separately. The parameters considered are the intrinsic nature of the catalyst used for the anode 37 of the fuel cell 34 and the pressure of the electrolyzer 21. For the experiments the electrolyzer 21 has been operated at 90° C. with a methanol concentration of 3 Molar.

The fuel cell 34 having Pt as a catalyst for the anode 37 performs very poorly as the current density at 0.6 V according to a data point 124 is very low. The data point 124 was difficult to measure as the current keeps decaying all the time to lower values without reaching any plateau. Thus, this particular data point 124 was taken after ten minutes of dwelling time at 0.6 V.

Next a fuel cell 34 with a anode 37 provided with PtRu showed some improvement in comparison to Pt as can be recognized from a curve 125, but the current density was still lower in comparison to a fuel cell 34 supplied with pure H₂ whose performance is illustrated by a curve 126. But if the electrolyzer 21 is pressurized to an overpressure of 2.7 bar, then the performance almost reaches the level comparable to a fuel cell 34 running with pure H₂ as is illustrated by curve 127.

Case 2: In this case the electrolyzer 21 is operated at 90° C. with 1 Molar methanol concentration and 2.2 bar absolute pressure in the electrolyzer 21 and condenser 72. Furthermore Pt is used for the anode 37 of the fuel cell 34. Under these conditions severe poisoning of fuel cell 34 is seen. But after changing the concentration of methanol to 0.5 Molar, it was possible to eliminate the poisoning to large extent, although using 0.5 Molar concentration for an electrolyzer 21 operating at high temperature and high current densities results in mass transport limitations.

Case 3: The electrolyzer 21 is operated at 110° C. with 3 Molar methanol concentration and 4 bar absolute pressure in the electrolyzer 21 and condenser 72. PtRu is used for the anode 37 of the fuel cell 34. Under these conditions mild poisoning of the fuel cell 34 is seen. But after applying the voltage pulse of 1 s periodically after 10-15 minutes, it was possible to completely eliminate the poisoning effect.

These examples show that pressurization of the electrolyzer 21 and the use of the poisoning tolerant catalyst may be sufficient in most cases to completely remove the harmful effect of anode poisoning. In some cases, however, it is necessary to make additional modification depending on the conditions of operation.

According to the mixed flow arrangement shown in FIG. 12 the gases leaving the anode and the cathode outlets of the electrolyzer 21 are mixed in one single fuel tank 81. This scheme eliminates the need for an extra assembly comprising a condenser, gas liquid separator or pressure regulating valve for the gas leaving the cathode 25 of the electrolyzer 21, which is very useful for designing small fuel cell systems. But mixing anode and cathode outlet also have a disadvantage, as it would allow more vapors of methanol or of MOR by-products to leave the fuel tank 81 along with CO₂ and H₂ gases. But the exact amount of methanol and MOR by-products vapors escaping with CO₂ and H₂ will be determined by the concentration of methanol, temperature and pressure of the fuel tank 81. The methanol or MOR byproducts vapors reaching the anode 37 of the fuel cell 34 along with the CO₂/H₂ mixture will poison the anode 37 of the fuel cell 34. Thus appropriate poisoning controlling measures must be taken to eradicate the bad effect of the poisoning on the performance of the fuel cell 34. In the following paragraphs, some experimental results are presented which demonstrate the effectiveness of different poisoning controlling measures for different set of operating conditions.

Mixed flow tests were performed in two different ranges of methanol concentration. One methanol solution is diluted around 3 Molar and another is 67 vol % methanol dilution which corresponds to a methanol-to-water ratio of 1:1. For miniaturized fuel cell systems, capturing water and using it to dilute pure methanol to a mixture with a methanol-to-water ratio less than 1:1 can be difficult under certain circumstances. One can only use maximum concentration of methanol taking into account the requirement of one water molecule for oxidation of each methanol molecule. This equimolar methanol water solution is 67 vol % methanol. For these reasons the following tests were performed using 67 vol % methanol for an mixed flow arrangement, which can provide valuable information about very practical conditions.

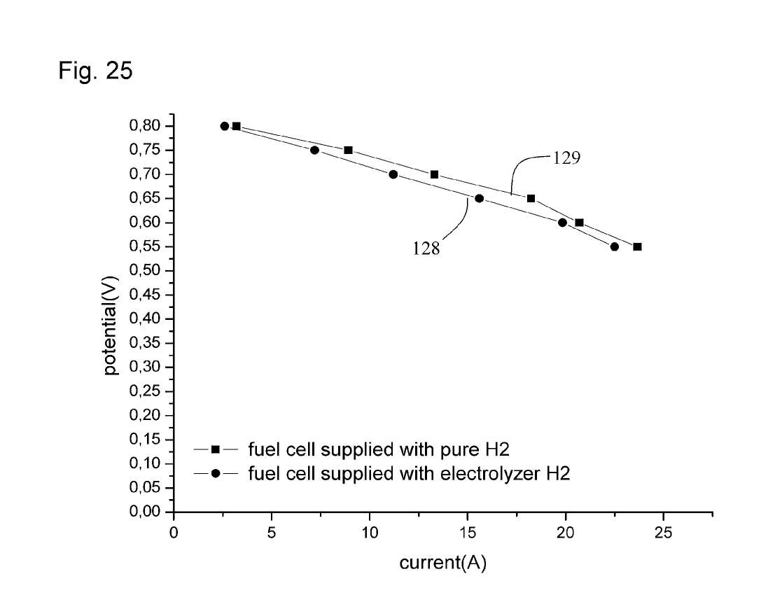

Case 4: PtRu is used as a catalyst for the anode 37 in the fuel cell 34. The electrolyzer 21 is operated at 90° C. fed with 3 Molar methanol dilution and the fuel tank 81 at room temperature. Under these conditions, performance tests of the fuel cell 34 were performed to determine the impact of the methanol and MOR by-products vapors on the performance of the fuel cell 34 under these experimental conditions. At ambient pressure operation of the electrolyzer 21, poisoning is seen, as the current densities in the fuel cell 34 are low. But as the pressure in the fuel tank 81 is raised, the current density in the fuel cell 34 also goes up. This is again due to the reduction in the amount of methanol and MOR by-products vapors arising at the anode 37 of the fuel cell 34 at higher pressure in the fuel tank 81. FIG. 25 shows the current-voltage characteristics of the fuel cell 34 with pure H₂ and H₂ from mixed flow electrolyzer 21 operating at 90° C. and 2.7 bar overpressure. The reduction in performance due to the mixed flow seems to be small since a curve 128 for the mixed flow mode deviates not much from a curve 129 for the operation of the fuel cell 34 with pure hydrogen.

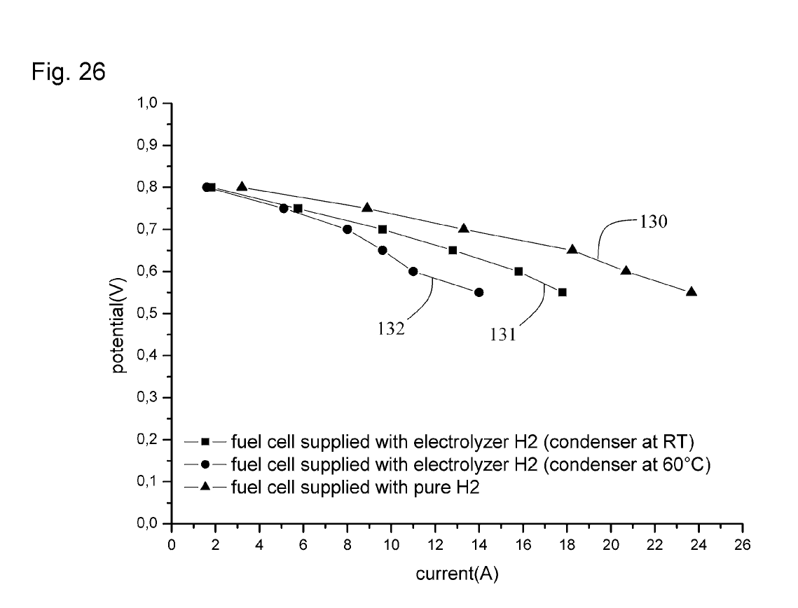

Case 5: PtRu is used as a catalyst for the anode 37 in the fuel cell 34. The electrolyzer 21 is operated at 60° C. and fed with 67 vol % methanol solution. Because of high concentration of methanol in the fuel tank 81, the amount of methanol MOR by-products vapor going out with H₂ and CO₂ gases is high. Also at high methanol concentrations, methanol oxidation reactions produce even more amount of volatile by-products; some of them are not possible to condense at room temperature. These two factors lead to severe poisoning of the fuel cell 34. At such a high concentration of methanol in the fuel and when the electrolyzer 21 is operated at 90° C., it was not possible to eliminate the poisoning effect even after pressurizing the electrolyzer 21 and fuel tank 81 to 4 bar. Thus the temperature of the electrolyzer 21 was reduced to 60° C. At this temperature and when the fuel tank 81 is kept at room temperature and pressurized to an absolute pressure of 3.3 bar, the poisoning effect is eliminated to a large extent as can be recognized from FIG. 26 in which a curve 130 represent the performance of the fuel cell 34 fed with pure hydrogen and a curve 131 represents the performance of the fuel cell 34 if the fuel tank is kept at room temperature and is pressurized to 3.3 bar. But the impact of poisoning the anode 37 of the fuel cell 34 is highest in the case in which the fuel tank 81 is heated to 60° C. This gives worst performance of the fuel cell 34 as can be recognized from a curve 132 in FIG. 26. At this temperature, even a high overpressure in the condenser tank 81 does not help bringing back the performance of the fuel cell 34 to the original level.

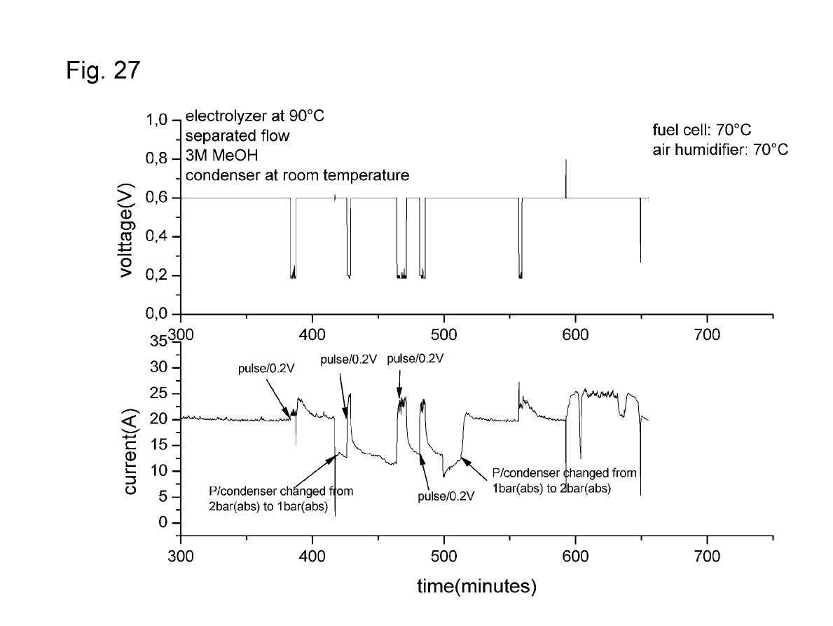

FIG. 27 presents further experimental results which show a poisoned and not-poisoned state of operation of the fuel cell 34 in the separate flow arrangement according to FIG. 11 under different operating conditions. In these experiments, the poisoning behavior of methanol and MOR byproduct vapors was studied for the fuel cell 34 providing the MEA 35 with the anode 37 based on PtRu. With the anode 37 based on PtRu, the poisoning due to methanol and MOR byproducts vapors is still present, but the extent of poisoning is smaller than the Pt anode case. As can be seen in FIG. 27, when the condenser 72 is pressurized to 2 bar(abs), the current in the fuel cell 34 is stable and high without any decay. But as the pressure in the condenser 72 is lowered to ambient pressure, the current decays from 20 A to a quasi-steady state value around 13 A and still keeps decaying, though a bit more slowly. The potential pulses to 0.2 V are not enough to remove the poisoning.

But as the pressure in the condenser 72 is raised to 2 bar(abs) again, the current in the fuel cell 34 comes back by itself to the previously high level. This simply implies that by raising the pressure in the condenser to 2 bar(abs), the amount of methanol and MOR byproducts vapor going out of the condenser along with H₂ into the anode 37 is lowered to tolerable levels.

Thus, the behavior of the fuel cell 34 can be called not-poisoned if the pressure is 2 bar(abs) as the current is high and stable over time. But if the pressure is 1 bar(abs) the behavior of fuel cell 34 has to categorized as poisoned, as after every cleaning low voltage pulse to 0.2V, the current again decays to low values and keep decaying with time.

### 8. Summary of the Invention

By physical separation of anode and cathode processes the EDMFC scheme improves the fuel utilization efficiency close to 100% and avoids fuel crossover and cathode flooding problems. The requirements on the flow stoichiometry are similar to a conventional PEMFC and pressurized operation is not required. The improvements in cathode performance in the EDMFCs allow to considerably reduce the catalyst loading of the effective cathode compared to the catalyst loading of a conventional DMFC. The EDMFC scheme allows the operation of the electrolyzer at elevated temperatures because of its self-generated pressure of H₂ and CO₂ gases. The high temperature operation entails lower anode catalyst loadings in the electrolyzer. For example, the autonomous operation of the electrolyzer 21 in the EDMFC at high temperature (80-100° C.) lead to five to six times lower anode catalyst loadings in comparison to a conventional DMFC running at 50-60° C. The new EDMFC concept is suitable for portable applications and all prospective applications of conventional DMFC. The EDMFC system can be built smaller in size and at low production costs compared to a conventional DMFC. Furthermore EDMFCs can be designed in a flexible way depending on the system requirement. These advantages are due to the fact, that the EDMFCs combines the advantageous properties of PEMFCs and electrochemical electrolyzers together with the advantageous properties of organic fuels, which provide a high energy densities.

Throughout the description and claims of this specification, the singular encompasses the plural unless the context other-wise requires. In particular, where the indefinite article is used, the specification is to be understood as contemplating plurality as well as singularity, unless the context requires otherwise.

Features, integers, characteristics, compounds or groups described in conjunction with a particular aspect, embodiment or example of the invention are to be understood to be applicable to any other aspect, embodiment or example described herein unless incompatible therewith.

TABLE 1

| | | | | | | | | Effective | |
|---|---|---|---|---|---|---|---|---|---|
| | | | P | | | | MEA | Cathode | |
| | T | U_{cell} | (bar | j | PD | P_{syst} | Area | Catalyst | m_{cat total} |
| | (° C.) | (V) | (abs)) | (mA/cm²) | mW/cm² | (mW) | (cm²) | Loading (mg) | (mg) |
| 1 | | | | | | | | | |
| DMFC | 77 | 0.4 | 1 | 80 | 32 | 137 | 4.28 | 9.8 | 26.5 |
| EDMFC | | 0.4 | 1 | | 41.5 | 137 | 3.3 | 2.8 | 7 |
| EL | 77 | 0.4 | 1 | 343 | | | 1 | | 4.7 |
| PEM | 60 | 0.8 | 1 | 150 | | | 2.3 | | 2.3 |
| 2 | | | | | | | | | |
| DMFC | 70 | 0.35 | 1.5 | | 50 | 92.7 | 1.85 | 4.25 | 11.5 |
| EDMFC | | 0.35 | | | 50 | 92.7 | 1.85 | 1.35 | 5.55 |
| EL | 70 | 0.4 | 1 | 265 | | | 1 | | |
| PEM | 60 | 0.75 | 1 | 310 | | | 0.85 | | |
| 2.1 | | | | | | | | | |
| DMFC | 70 | 0.35 | 1.5 | | 50 | 196 | 4 | | 24.8 |
| EDMFC | | 0.35 | 1 | | 70 | 196 | 2.8 | | 6.5 |
| EL | 90 | 0.4 | 1 | 560 | | | 1 | | 4.7 |
| PEM | 60 | 0.75 | 1 | 310 | | | 1.8 | | 1.8 |
| 3 | | | | | | | | | |
| DMFC | 77 | 0.35 | 1 | 100 | 35 | 120 | 3.42 | 7.86 | 21 |
| EDMFC | | 0.35 | | | 57 | 120 | 2.1 | 1.5 | 5.8 |
| EL | 77 | 0.4 | 1 | 343 | | | 1 | | 4.7 |
| PEM | 60 | 0.75 | 1 | 310 | | | 1.1 | | 1.1 |
| 4 | | | | | | | | | |
| DMFC | 80 | 0.4 | 3 | | 80 | 148 | 1.85 | 4.25 | 11.5 |
| EDMFC | | 0.4 | | | 42.7 | 148 | 3.47 | 2.97 | 7.16 |
| EL | 80 | 0.4 | 1 | 370 | | | 1 | | |
| PEM | 60 | 0.8 | 1 | 150 | | | 2.47 | | |
| 5 | | | | | | | | | |
| DMFC | 80 | 0.4 | 3 | | 80 | 76 | 0.95 | 2.18 | 5.89 |
| EDMFC | | 0.4 | | | 47 | 76 | 1.61 | 1.1 | 5.31 |
| EL | 80 | 0.35 | 1 | 190 | | | 1 | | 4.7 |
| PEM | 60 | 0.75 | 1 | 310 | | | 0.61 | | 0.61 |
| 6 | | | | | | | | | |
| DMFC | 80 | 0.4 | 3 | | 80 | 200 | 2.5 | 5.75 | 15.5 |
| EDMFC | | 0.4 | | | 53 | 200 | 3.78 | 3.28 | 7.48 |
| EL | 90 | 0.386 | 1 | 500 | | | 1 | | |
| PEM | 60 | 0.79 | 1 | 180 | | | 2.78 | | |
| 7 | | | | | | | | | |
| DMFC | 80 | 0.4 | 3 | | 80 | 139 | 1.74 | 4.00 | 10.8 |
| EDMFC | | 0.4 | | | 65 | 139 | 2.12 | 1.62 | 5.82 |
| EL | 90 | 0.35 | 1 | 348 | | | 1 | | |
| PEM | 60 | 0.75 | 1 | 310 | | | 1.12 | | |
| 8 | | | | | | | | | |
| DMFC | 80 | 0.4 | 3 | | 80 | 49.6 | 0.62 | 1.42 | 3.8 |
| EDMFC | | 0.4 | | | 40.3 | 49.6 | 1.23 | 0.73 | 4.93 |
| EL | 90 | 0.3 | 1 | 124 | | | 1 | | 4.7 |
| PEM | 60 | 0.7 | 1 | 530 | | | 0.23 | | |
| 9 | | | | | | | | | |
| DMFC | 80 | 0.3 | 3 | | 100 | 174 | 1.74 | 4.0 | 10.8 |
| EDMFC | | 0.3 | 1 | | 83 | 174 | 2.1 | 1.5 | 5.8 |
| EL | 90 | 0.4 | 1 | 580 | | | 1 | | 4.7 |
| PEM | 60 | 0.7 | 1 | 530 | | | 1.1 | | 1.1 |
| 10 | | | | | | | | | |
| DMFC | 22 | 0.4 | 1 | 18.9 | 7.6 | 7.2 | 0.95 | 2.18 | 5.89 |
| EDMFC | | 0.4 | 1 | | | 7.2 | 1.12 | 0.62 | 4.82 |
| EL | 25 | 0.4 | 1 | 18 | | | 1 | | 4.7 |
| PEM | 60 | 0.8 | 1 | 150 | | | 0.12 | | 0.12 |
| 11 | | | | | | | | | |
| DMFC | 80 | 0.3 | 3 | | 100 | 348 | 3.48 | 8.0 | 21.6 |
| EDMFC | | 0.3 | | | 109 | 348 | 3.18 | 2.68 | 6.88 |
| EL | 110 | 0.4 | 3 | 1160 | | | 1 | | 4.7 |
| PEM | 60 | 0.7 | 1 | 530 | | | 2.18 | | 2.18 |

TABLE 2

| Parameter | DMFC | EDMFC |
|---|---|---|
| Electrical efficiency | 0.46 | 0.23 |
| Fuel efficiency | 0.54 | nearly 1 |
| System efficiency | 0.78 | 0.85 |
| Total efficiency | 0.19 | 0.19 |
| | (912 Whr/L; pure | (912 Whr/L; pure |
| | methanol as fuel) | methanol as fuel) |
| Single cell voltage (V) | 0.55 | 0.27 |
| Temperature (° C.) | 65° C. | EL: 110° C., FC: |
| | | 60-80° C. |
| Power per gram of noble metal | 5-15 | 80-120 |
| catalyst (W/g) | | |
| Power density of stack | 46 | 100-190 |
| (mW/cm²) | | |

1. A system for generating electrical energy comprising:
a fuel reservoir for storage of an organic fuel;
an electrochemical reformer provided with electrical current terminals and arranged for converting the fuel from the fuel reservoir into fuel gas provided at a fuel gas outlet of the reformer;
an electrochemical generator having a fuel gas inlet connected to the fuel gas outlet of the reformer, comprising electrical current terminals connectable to an external load and arranged for the production of electrical energy using the fuel gas;
an electrical connection between the electrical current generator and the reformer for supplying electrical energy generated by the generator to the electrical current terminals of the reformer, wherein
a separator is disposed between reformer and generator for separating liquids from the fuel gas supplied to the generator and that
a poisoning tolerant catalyst is used for an electrode on the fuel gas side of the generator.

2. The system according to claim 1, wherein the poisoning tolerant catalyst on the electrode on the fuel gas side of the generator is a catalyst whose performance is better than the performance of Pt in the presence of fuel vapor and to by-products of the fuel gas generation process on the fuel gas side of the generator under the same operational conditions.

3. The system according to claim 2, wherein the fuel tolerant catalyst on the electrode on the fuel gas side of the generator is based on a alloy comprising Pt and at least one component of the group Sn, Ru, W, Mo, Rh and Re.

4. The system according to claim 1, wherein the fuel concentration in the reformer is chosen below a concentration limit Cₗᵢₘᵢₜ given by Cₗᵢₘᵢₜ=17 Molar at operational temperatures below 70° C., Cₗᵢₘᵢₜ=7 Molar at operational temperatures above 100° C. and Cₗᵢₘᵢₜ=17 Molar−⅓*(T−70° C.) Molar in the temperature range between 70° and 100° C.

5. The system according to claim 1, wherein the voltage of each elementary cell of the generator is periodically pulsed to a voltage less than 0.5 Volt.

6. The system according to claim 1, wherein at least one component selected from the group comprising the reformer, a separator, a fuel tank and a condenser for the waste gas are pressurized above ambient pressure for reducing the amount of fuel vapor and fuel oxidation by-products arriving at the generator together with fuel gas.

7. The system according to claim 6, wherein the reformer is pressurized and that the choice of pressure is governed by the relation:
(U[V]−0.276[J/C](p/(P−p)))>0
where U is the single cell voltage of the reformer, which may assume values between 0.2 V<U<0.7 V, P is the total operating pressure of the reformer ranging between 0<P<8 atm and p=p(C, T) is the combined partial pressure of fuel and water vapors in the reformer, which is a function of temperature T and fuel concentration C in a fuel diluting fluid.

8. The system according to claim 1, wherein the separator is additional supplied with waste gas from the fuel side of the reformer and that a condensate is conducted back to the fuel side of the reformer.

9. The system according to claim 1, wherein the catalyst loading of an electrode on the fuel side of at least one elementary cell of the reformer is higher than the catalyst loading of an electrode on the fuel gas side of the elementary cell of the reformer.

10. The system according to claim 9, wherein the total amount of catalyst used for an electrode on the fuel side of the reformer is higher than the total amount of catalyst used for an effective cathode comprising the electrode on the fuel gas side of the reformer and the electrodes in the generator.

11. The system according to claim 1, wherein the electrical system power per total catalyst loading exceeds 100 W/g at an actual electrical power density above 100 mW/cm² with respect to the geometrical area of the electrodes and a total efficiency between 10% and 30%.

12. The system according to claim 1, wherein the electrical system power per total catalyst loading exceeds 30 W/g at an actual electrical power density above 40 mW/cm² with respect to the geometrical area of the electrodes and a total efficiency above 30%.

13. The system according to claim 1, wherein the reformer comprises a porous membrane electrode assembly and porous gas diffusion layers which are permeable for the fuel, the produced waste gas and fuel gas.

14. The system according to claim 13, wherein the reformer comprises a sequence of elementary cells with an anode and a cathode wherein the anode of a particular elementary cell is arranged next to the cathode of an adjacent elementary cell and the cathode of the particular elementary cell is arranged next to the anode of another adjacent elementary cell or wherein an anode of a particular elementary cell is arranged next to the anode of an adjacent elementary cell and a cathode of a particular elementary cell is arranged next to the cathode of another adjacent elementary cell.

15. The system according to claim 1, wherein hydrogen is used as a fuel gas, a hydrocarbon containing oxygen is used as a fuel and the waste gas produced by the reformer is carbon dioxide.

16. The system according to claim 15, wherein methanol or ethanol is used as a fuel.
